(19) United States
(12) Patent Application Publication
(10) Pub. No.: US 2007/0233688 A1
(43) Pub. Date: Oct. 4, 2007

(54) ONLINE SYSTEM FOR EXCHANGING FRAUD INVESTIGATION INFORMATION

(76) Inventors: Karla Weekes Smolen, Marietta, GA (US); Mark Edward Smolen, Marietta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/696,452

(22) Filed: Apr. 4, 2007

Related U.S. Application Data
(60) Provisional application No. 60/788,961, filed on Apr. 4, 2006.

(51) Int. Cl. G06F 17/30

(52) U.S. Cl. 707/9

(57) ABSTRACT

Systems, methods, and software for selectively sharing fraud investigative information or cases between two or more investigative entities. The system enables one entity to make its cases selectively viewable and searchable to other entities with access to the system. The one entity specifies whether the entire case file is accessible or whether only portions of the case are accessible. The system further enables the entities to exchange an increasing amount of detail and to collaborate regarding fraud investigation files as warranted by facts of the investigation. The system further provides a case management system for use by entities in managing their own fraud investigation cases and for sharing information in an easy and effective manner within their own organizations.

### CROSS-REFERENCE TO RELATED PATENT APPLICATION

This application claims the benefit, pursuant to 35 U.S.C. §119(e), of U.S. provisional patent application Ser. No. 60/788,961, filed Apr. 4, 2006, entitled “Online System for Exchanging Fraud Investigation Information,” which is incorporated herein by reference in its entirety.

### FIELD OF THE INVENTION

The present invention relates generally to an electronic platform that enables the secure sharing of information and, in particular, to a system and method for identifying overlapping fraud investigations between or among different organizations, including Federal, state and commercial entities, and potentially across state lines for the purpose of facilitating contact and collaboration on such investigations while maintaining each entities' anonymity and case integrity prior to mutually agreed contact or collaboration, and also to a system and method for creating, managing, conducting, tracking and reporting fraud investigations between and among a plurality of agencies and departments.

### BACKGROUND OF THE INVENTION

The concept of a contributory database where proprietary data is shared and accessed between potentially competitive agencies is not unique in today's business world. The CLUE™ database by Choicepoint Inc. (Alpharetta, Ga.) is a database that shares claims information on property and casualty insurance clients with agencies making inquiry requests. CLUE™ is used by the claims insurance underwriters to assess the kind of risk that a potential client poses, so that rate information can be set appropriately to that particular prospect's recent claims history. This database has been extremely helpful to the property and casualty insurance market, and continues to be heavily utilized to ensure that rates can be set appropriately, and that profits for these companies might be maximized.

The Current Carrier™ database by Choicepoint Inc. is a similar database that the property and casualty insurance companies also contribute to and access for information. This database contains the current client list from most property and casualty insurance companies. This can be used to see if a client is currently holding property and/or casualty insurance. This information is also used to set rates on a potential client to see whether a client is an “insurance hopper,” where they change insurance frequently, and allow periods of time to pass where they will go uninsured. These are more risky patterns of behavior, and as such, will be rated appropriately.

In both of the above cases, Choicepoint acts as the third party to match the inquiry request against the database and return information against the inquiry. The information that is needed for these insurance agencies to make these types of decisions is proprietary sensitive data, and they realize the value of allowing a third party to control it, to lower the whole industry's costs of doing business. Also, the third party (Choicepoint) is an independent/non-partisan/neutral entity that poses little or no conflict of interest to the competitive parties represented. However, both systems automatically pass all detailed information between entities.

In addition, there is currently no system that enables fraud investigatory information to be shared selectively and in a controlled manner between enforcement entities at the commercial, state and Federal levels.

Therefore, a heretofore unaddressed need exists in the art to address the aforementioned deficiencies and inadequacies.

### SUMMARY OF THE INVENTION

In one aspect, the present invention relates to a system for selectively sharing information including a plurality of cases, where each of the plurality of cases is associated with an entity. In one embodiment, the system includes a database for storing the information; a web server in communication with the database for managing the information therein; and a policy control module in communication with the database and the web server for creating rules to allow an entity to limit to whom his/her case is exposed, such that when entity A is assigned to share with entity B, the case associated with entity A is exposable/searchable to entity B, and vice versus.

The system further includes a data ingest module adapted for receiving cases from existing case tracking systems; receiving search indices from a remotely deployed system application; applying a secured file transfer protocol (SFTP) for automated upload cases into a hot folder per entity; performing data normalization for batch upload; creating and/or entering a individual case; and ingesting past action data file.

The system may also include a case management module adapted for entering, editing, reviewing, and/or disposing of cases, a case collaboration module adapted for generating a request for information (RFI) on behalf of another entity, and deciding what information can be shared, a search module adapted for searching cases for various attribute data in accordance with search criteria of an entity, and a reporting module adapted for generating reports in accordance with the needs and requirements of the entity.

In another aspect, the present invention relates to a method for selectively sharing information including a plurality of cases, where each of the plurality of cases is associated with an entity. In one embodiment, the method includes the steps of providing a database to store the information; providing a web server in communication with the database for managing the information therein; and creating rules to allow an entity to limit to whom his/her case is exposed, such that when entity A is assigned to share with entity B, the case associated with entity A is exposable/searchable to entity B, and vice versus.

Furthermore, the method includes one or more steps of receiving cases from existing case tracking systems; receiving search indices from a remotely deployed system application; applying a secured file transfer protocol (SFTP) for automated upload cases into a hot folder per entity; performing data normalization for batch upload; creating and/or entering a individual case; and ingesting past action data file.

The method also includes one or more steps of entering, editing, reviewing, and/or disposing of cases, generating a request for information (RFI) on behalf of another entity, and deciding what information can be shared, searching cases for various attribute data in accordance with search criteria of an entity, and generating reports in accordance with the needs and requirements of the entity.

In yet another aspect, the present invention relates to software stored on a computer readable medium for causing a computing system to perform functions comprising storing a plurality of cases, each of the plurality of cases being associated with an entity; and creating rules to allow an entity to limit to whom his/her case is exposed, such that when entity A is assigned to share with entity B, the case associated with entity A is exposable/searchable to entity B, and vice versus.

In one embodiment, the functions further comprise receiving cases from existing case tracking systems; receiving search indices from a remotely deployed system application; applying a secured file transfer protocol (SFTP) for automated upload cases into a hot folder per entity; performing data normalization for batch upload; creating and/or entering a individual case; and ingesting past action data file.

The functions also comprise entering, editing, reviewing, and/or disposing of cases, generating a request for information (RFI) on behalf of another entity, and deciding what information can be shared, searching cases for various attribute data in accordance with search criteria of an entity, and generating reports in accordance with the needs and requirements of the entity.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows schematically a component view of a system according to one embodiment of the present invention;

FIG. 2 shows a flowchart of system inputs of the system according to one embodiment of the present invention;

FIG. 3 shows a flowchart of binding agreements of the system according to one embodiment of the present invention;

FIG. 4 shows a user interface of a home page of the system according to one embodiment of the present invention;

FIG. 5 shows a user interface of a login page of the system according to one embodiment of the present invention;

FIG. 6 shows a user interface of a request account page of the system according to one embodiment of the present invention;

FIG. 7 shows a user interface of a change password page of the system according to one embodiment of the present invention;

FIG. 8 shows a user interface of a forgotten password page of the system according to one embodiment of the present invention;

FIG. 9 shows a page of exemplary terms of use of the system according to one embodiment of the present invention;

FIG. 10 shows a user interface of an administrative dashboard page of the system according to one embodiment of the present invention;

FIG. 11 shows a user interface of an administrator case assignment page of the system according to one embodiment of the present invention;

FIG. 12 shows a user interface of an administrator account management page of the system according to one embodiment of the present invention;

FIG. 13 shows a user interface of an existing account details and reporting page of the system according to one embodiment of the present invention;

FIG. 14 shows a user interface of an account details request page of the system according to one embodiment of the present invention;

FIG. 15 shows a user interface of a my dashboard page of the system according to one embodiment of the present invention;

FIGS. 16-19 show a user interface of new case creation wizard pages 1-4, respectively, of the system according to one embodiment of the present invention;

FIG. 20 shows a user interface of a my case page of the system according to one embodiment of the present invention;

FIG. 21 shows a user interface of a case detail page of the system according to one embodiment of the present invention;

15 FIG. 22 shows a user interface of a subject info page of the system according to one embodiment of the present invention;

FIG. 23 shows a user interface of a case log page of the system according to one embodiment of the present invention;

FIG. 24 shows a user interface of a case reassigned page of the system according to one embodiment of the present invention;

FIG. 25 shows a user interface of a case disposition page of the system according to one embodiment of the present invention;

FIG. 26 shows a user interface of a supporting docs page of the system according to one embodiment of the present invention;

FIG. 27 shows a user interface of a past sanctions page of the system according to one embodiment of the present invention;

FIG. 28 shows a user interface of a company cases page of the system according to one embodiment of the present invention;

FIG. 29 shows a user interface of a company case detail page of the system according to one embodiment of the present invention;

FIG. 30 shows a user interface of a create case report page of the system according to one embodiment of the present invention;

FIG. 31 shows a user interface of a report generation confirmation page of the system according to one embodiment of the present invention;

FIG. 32 shows a user interface of a closed case detail page of the system according to one embodiment of the present invention;

FIG. 33 shows a user interface of a reporting page of the system according to one embodiment of the present invention;

FIG. 34 shows a user interface of a case search page of the system according to one embodiment of the present invention;

FIG. 35 shows a user interface of a search result page of the system according to one embodiment of the present invention;

FIG. 36 shows a user interface of a hot sheet page of the system according to one embodiment of the present invention;

FIG. 37 shows a user interface of a collaboration page of the system according to one embodiment of the present invention;

FIG. 38 shows a user interface of a view request page of the system according to one embodiment of the present invention;

FIG. 39 shows a user interface of a request from hot sheet page of the system according to one embodiment of the present invention; and

FIG. 40 shows a user interface of a request from search page of the system according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention. Additionally, some terms used in this specification are more specifically defined below.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### DEFINITIONS

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatus and methods of the invention and how to make and use them. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

As used herein, “about” or “approximately” shall generally mean within 20 percent, preferably within 10 percent, and more preferably within 5 percent of a given value or range. Numerical quantities given herein are approximate, meaning that the term “about” or “approximately” can be inferred if not expressly stated.

As used herein, the term “system” refers to a set of entities, real or abstract, comprising a whole where each component interacts with or is related to at least one other component and they all serve a common objective, i.e., a framework of software or hardware, designed to allow the searching and sharing of case information between different subscriber entities, and a system to enter, log and track case information by/for single entity purposes. The system also has document management and assembly tools that are used for reporting and collaboration.

As used herein, the term “problem” refers to the inability to know that other entities are investigating the same individuals or facilities.

### OVERVIEW OF THE INVENTION

Among other things, the present invention relates to a system in which key elements are being matched when either a search is entered manually or using an automated daily/real-time routine. The system does not automatically pass detailed information between entities, but acts as a conduit between entities to facilitate information sharing. Obviously, for this matching, collaboration, and sharing of data to take place effectively, data needs to be entered into the system. It is expected and, generally preferred, for all participants to populate the central database with their information. There is a rules engine to help facilitate the limitations of each entity's information sharing, but ultimately, the decision on whether to collaborate or share information is based on each entity's preferences and they control this portion of detailed sharing of information.

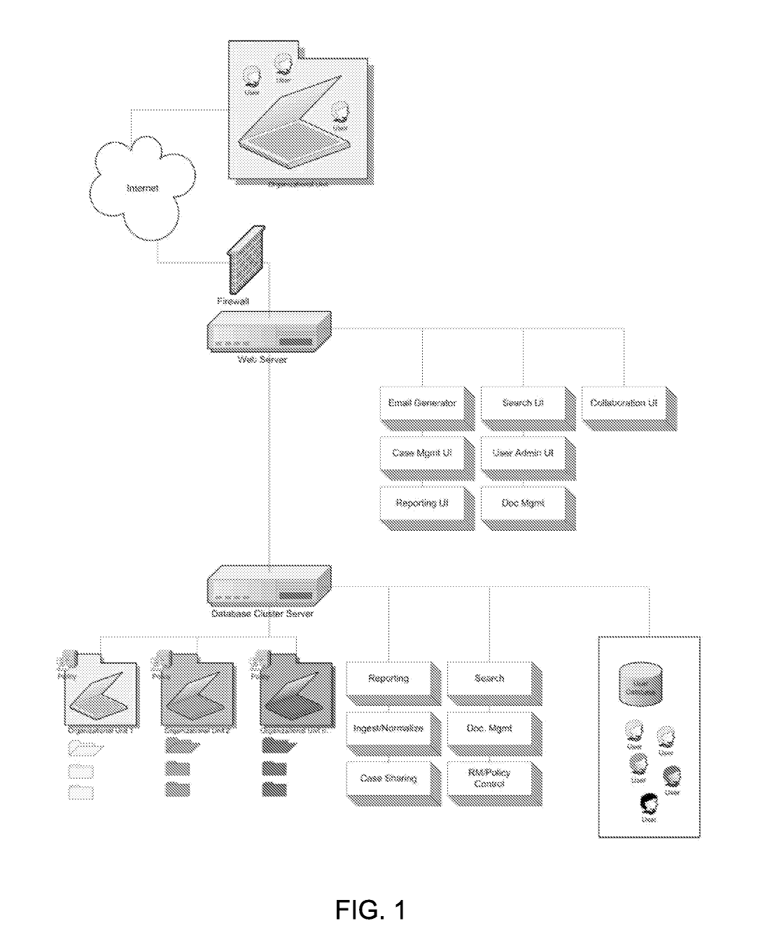

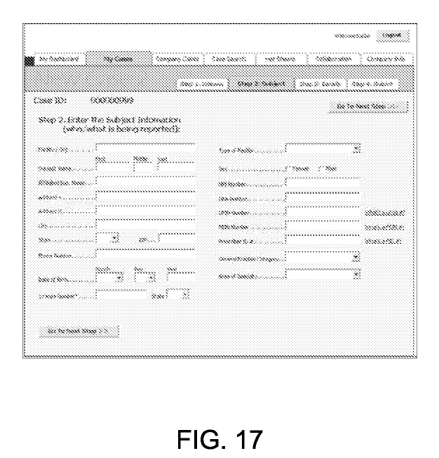

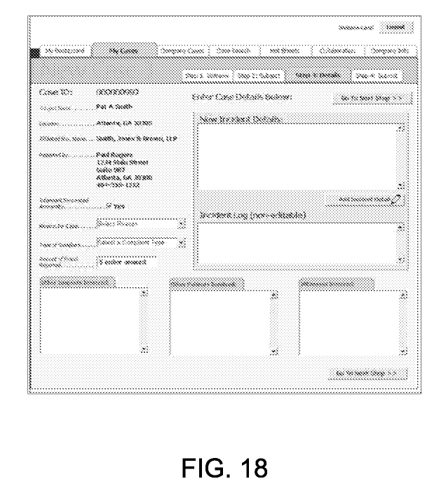

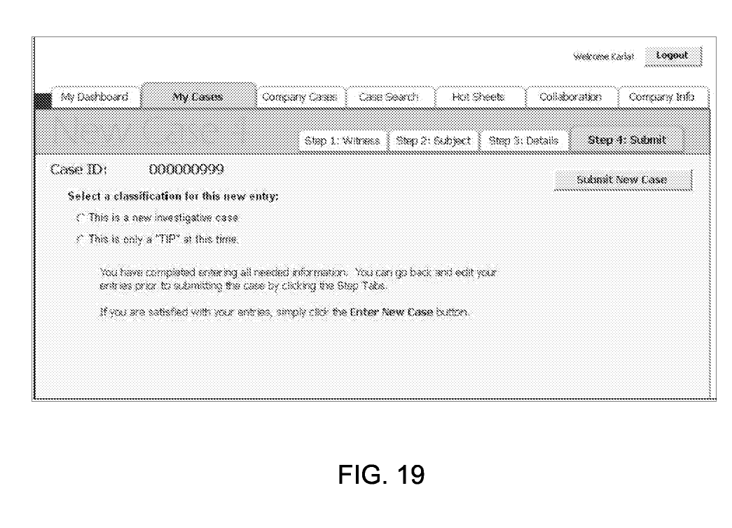

The description will be made as to the embodiments of the present invention in conjunction with the accompanying drawings of FIGS. 1-40. In accordance with the purposes of this invention, as embodied and broadly described herein, this invention, in one aspect, relates to a method for selectively sharing information including a plurality of cases, where each of the plurality of case is associated with an entity.

In one embodiment, the method includes the steps of providing a database to store the information; providing a web server in communication with the database for managing the information therein; and creating rules to allow an entity to limit to whom his/her case is exposed, such that when entity A is assigned to share with entity B, the case associated with entity A is exposable/searchable to entity B, and vice versa.

The method further includes one or more steps of receiving cases from existing case tracking systems; receiving search indices from a remotely deployed system application; applying a secured file transfer protocol (SFTP) for automated upload cases into a hot folder per entity; performing data normalization for batch upload; creating and/or entering a individual case; and ingesting past action data file.

The method also includes one or more steps of entering, editing, reviewing, and/or disposing of cases, generating a request for information (RFI) on behalf of another entity, and deciding what information can be shared, searching cases for various attribute data in accordance with search criteria of an entity, and generating reports in accordance with the needs and requirements of the entity.

An another aspect of the present invention provides software stored on a computer readable medium for causing a computing system to perform functions comprising storing a plurality of cases, where each of the plurality of cases is associated with an entity; and creating rules to allow an entity to limit to whom his/her case is exposed, such that when entity A is assigned to share with entity B, the case associated with entity A is exposable/searchable to entity B, and vice versus.

In one embodiment, the functions further comprise receiving cases from existing case tracking systems; receiving search indices from a remotely deployed system application; applying a secured file transfer protocol (SFTP) for automated upload cases into a hot folder per entity; performing data normalization for batch upload; creating and/or entering a individual case; and ingesting past action data file.

The functions also comprise entering, editing, reviewing, and/or disposing of cases, generating a request for information (RFI) on behalf of another entity, and deciding what information can be shared, searching cases for various attribute data in accordance with search criteria of an entity, and generating reports in accordance with the needs and requirements of the entity.

Yet another aspect of the present invention provides a system to implement the above disclosed method. In one embodiment, the system includes a database for storing the information; a web server in communication with the database for managing the information therein; and a policy control module in communication with the database and the web server for creating rules to allow an entity to limit to whom his/her case is exposed, such that when entity A is assigned to share with entity B, the case associated with entity A is exposable/searchable to entity B, and vice versa. The system is described in further details below.

### 1. System Description

### 1.1. System Design.

FIG. 1 represents a component view of the system according to one embodiment of the present invention. The system includes a Data Ingest Module, a Case Management User Interface (UI), a Case Collaboration Module, Search UI/Hot Sheets, a User Administration Module, a Reporting Module, an Email Generation Module, and a Document Management Module. All the modules and UIs are in communication with each other. Each module and UI of the system is briefly described below.

The Data Ingest Module in one embodiment includes:
means for receiving Case Data from existing case tracking systems;
means for receiving Search Indices from remotely deployed system application;
SFTP (Secured File Transfer Protocol) or other secure transfer mechanism for automated upload into a “hot folder” per entity;
data normalization for batch upload;
   XML or other data file input formats;
   Data mapping defined at the time of subscription setup; and
   Address data checked and normalized using USPS, CPS databases;
Case Entry UI for individual case creation and/or entry, where data are normalized and/or validated within the UI; and
Ingest Past Action Data file from CMS, DEA, etc. (periodically).

The Case Management UI includes a user interface for entering, editing, reviewing, and/or disposing of cases, in the terms of Standard Fields and Freeform text. The Case Management UI is configured such that a user can alter the “state” of the case(s); attach supporting documentation files (Doc Mgmt); and print or generate a PDF containing all case information.

The Case Collaboration Module in one embodiment includes a mechanism for generating the Request for Information (RFI) on behalf of another entity, and a Case Report generation interface, where a user can decide what information can be shared (checkboxes for each field, document, etc.). Additionally, the Case Collaboration Module is configured such that when HIPAA data or other sensitive information are accessed, a message of Freeform text warning is prompted, which warns the user not to share HIPAA data or other sensitive information, etc., and the system automatically excludes data marked as “regulated” (e.g. HIPAA/confidential).

The Search UI/Hot Sheets are used to search current cases for various attribute data—custom search criteria, to search Past Case/Action data; and Hot Sheet Automated Search and Results UI.

The User Administration Module is adapted for creating Admin Accounts; and controlling Rules Engine, creating User Accounts, approving and/or validating User Account requests (User Admin), deleting Users, re-assigning Users, resetting Password; and setting user Preferences defined at subscription time.

In one embodiment, the Reporting Module is configured to generate Usage Reports, interactive Reports, and Hot Sheet data.

The Email Generation Module is configured to look into Reporting Table for data, to generate emails to each investigator on case matches “Hot Sheets,” and to generate Notification Emails informing each user the current state of all cases.

The Document Management Module is configured to upload other documents/assets to be stored and/or associated to a case, to share documents, to delete documents; to generate PDF from various document types, to generate case documents; and to preview documents without download.

### 1.2. System Inputs

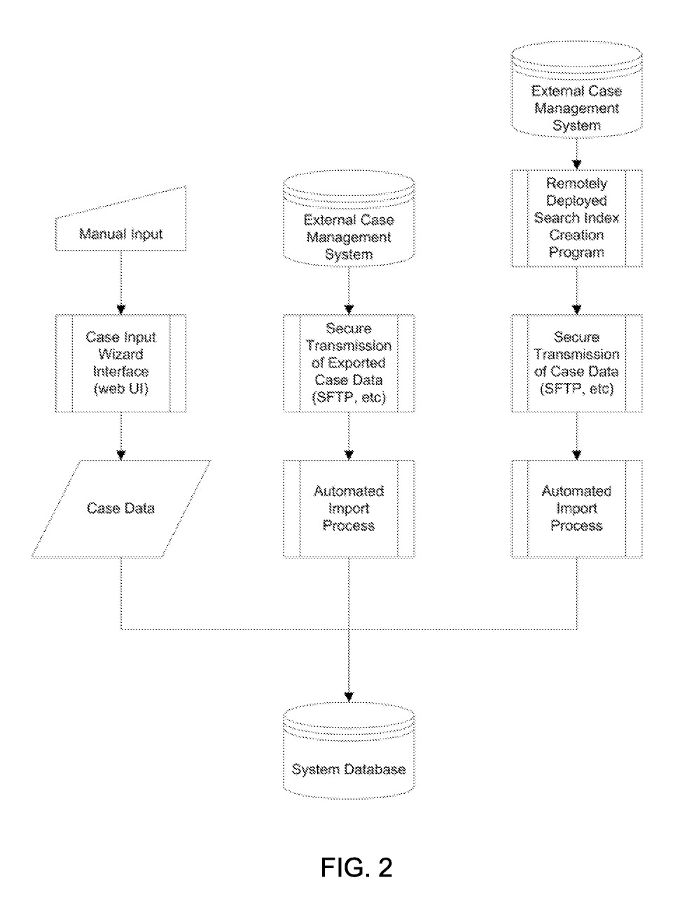

FIG. 2 shows a flowchart of the system inputs of the system according to one embodiment of the present invention.

According to one embodiment of the present invention, the system accepts audit case information or search key indices from subscriber entities. The case information has three distinct entry points, which are: (1) an end-user entry of case information using the system's UI; (2) a batch upload of case information from existing case tracking systems; and (3) a batch upload of prepared search indices from remotely deployed application.

The third method involves deploying an external software mechanism that interfaces with an entity's existing system. The mechanism “crawls” the existing case management tool (CMT) and creates a search index that can be used by the system's searching tools. Another variant (not shown) of this tool simply acts as an interface to the entity's existing system. In this case, the deployed mechanism receives search criteria from the system, performs a search against the existing CMT, and returns to the system a set of results. Searches are essentially federated to the external systems and result sets are returned. This method is really only usable to perform searching and initiate contact between entities. No actual case data is stored in the system until such time when a user creates a case and uploads data to share manually.

### 1.3. Binding Agreements for the Use of Collaborative Data

It is a common policy in law enforcement to share data between entities where/when appropriate. Often, a formal agreement is put in place prior to any data being shared. Such agreements are typically called a “Memo of Understanding” or MOU. The MOU is used to state how the data is to be used and treated by each sharing entity. The system supports the ability to enforce the use of MOU documents for one or both entities participating in a collaborative case. As described in section 4.1 below, the system maintains a Rules Engine that defines with which other entities each entity may search/collaborate. The Rules Engine also tracks and enforces the need for an MOU between the selected entities.

The system provides a mechanism to upload and manage any number of “boilerplate MOU” documents, which can be completed in real time using standard forms based publishing tools for the entry of participating parties' information, etc.

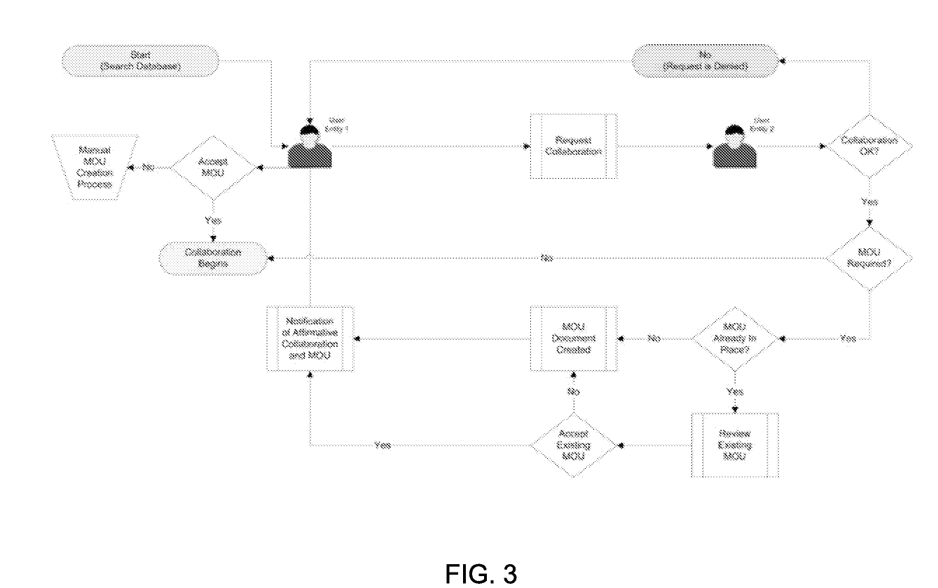

FIG. 3 shows a flowchart of the binding agreements for the use of collaborative data of the system according to one embodiment of the present invention.

As a first step in collaboration, the system guides the user through the creation, sending and tracking of the MOU. Once the MOU has been accepted by both parties, the system maintains the document within every collaborative case between the two entities. At the start of any subsequent collaboration, the system prompts the user to review and accept the current MOU or create a new one prior to collaboration starting. If a proposed MOU is not accepted, the system will direct the users manually to compose and accept an MOU prior to any collaboration occurring within the system.

These and other aspects of the present invention are more specifically described below.

### IMPLEMENTATIONS AND EXAMPLES OF THE INVENTION

Without intent to limit the scope of the invention, exemplary methods and their related results according to the embodiments of the present invention are given below.

### 2. Web Pages Overview

### 2.1. Page Tree

The following is a representative, but not all-inclusive, site map of the system of a preferred embodiment. Some pages may be referenced from multiple pages (not necessarily just in the area they are listed here).

| | |
|---|---|
| 1) | Home |
| 2) | Login |
| 3) | Request Account |
| 4) | Request Sent |
| 5) | Why we ask |
| 6) | Change Password |
| 7) | Password Changed |
| 8) | Forgotten Password |
| 9) | Password Reset |
| 10) | My Dashboard |
| 11) | My Cases |
| 12) | Case Detail |
| 13) | Subject Info |
| 14) | Case Log |
| 15) | Case Disposition |
| 16) | Case Reassigned |
| 17) | Calendar View |
| 18) | Edits Saved |
| 19) | Confirm Case Closure |
| 20) | Case Closed |
| 21) | Whats a Case Lock |
| 22) | Supporting Docs |
| 23) | Doc Mmgmt Helper info |
| 24) | Past Sanctions |
| 25) | Supporting Doc Added |
| 26) | Sanction page 2 |
| 27) | Helper Info |
| 28) | Create Case Report |
| 29) | Report is Being Generated |
| 30) | Company Cases |
| 31) | Closed Case Detail |
| 32) | Company Case Detail |
| 33) | Case Linked |
| 34) | Company Subject |
| 35) | Company Log |
| 36) | Company Doc Mgmt |
| 37) | Company Create Report |
| 38) | Report Added |
| 39) | Case Search |
| 40) | Case Search Subject |
| 41) | Search Results |
| 42) | Link To Case |
| 43) | Search Criteria |
| 44) | Whats a DEA |
| 45) | Whats a FEIN |
| 46) | Whats a NPI |
| 47) | Whats a UPIN |
| 48) | Whats This Past Sanctions DB |
| 49) | Whats a PID |
| 50) | Relative Search Help |
| 51) | Hot Sheets |
| 52) | Cleared All |
| 53) | Cleared Selected |
| 54) | Company Info |
| 55) | Collaboration Page |
| 56) | Case Collab Setup |
| 57) | Collab Report Generated |
| 58) | Request from Hot Sheet |
| 59) | Send Response Anonymous |
| 60) | Send Response Jack |
| 61) | Request from Search |
| 62) | Whats a Placeholder |
| 63) | RFI Sent |
| 64) | Response Sent |
| 65) | Create New Case 1 |
| 66) | Create New Case 2 |
| 67) | Create New Case 3 |
| 68) | Create New Case 4 |
| 69) | Case Entered |
| 70) | Administrator Page |
| 71) | Reports |
| 72) | Case Assignment |
| 73) | Data Upload |
| 74) | Account Management |
| 75) | Account Details Existing |
| 76) | Account Details Request |
| 77) | Confirm Activation |
| 78) | Confirm Denial |
| 79) | Confirm Reset |
| 80) | Confirm Blocking |
| 81) | Confirm Suspend |
| 82) | Confirm Remove |
| 83) | Invalid Removal Attempted |
| 84) | Solutions |
| 85) | Healthcare Solution |
| 86) | Banking Solution |
| 87) | How It Works |
| 88) | Flash Demo |
| 89) | Support |
| 90) | Ask Question |
| 91) | Question Sent |
| 92) | Bug Report |
| 93) | Report Sent |
| 94) | Password Reset Request |
| 95) | Reset Request Sent |
| 96) | Customers |
| 97) | News and Events |
| 98) | About Us |
| 99) | Request Info |
| 100) | White Paper Request |
| 101) | Referral |
| 102) | Sign Up |
| 103) | Privacy |

### 3. Detail System Design—Public Facing Web Interface

### 3.1. Home Page

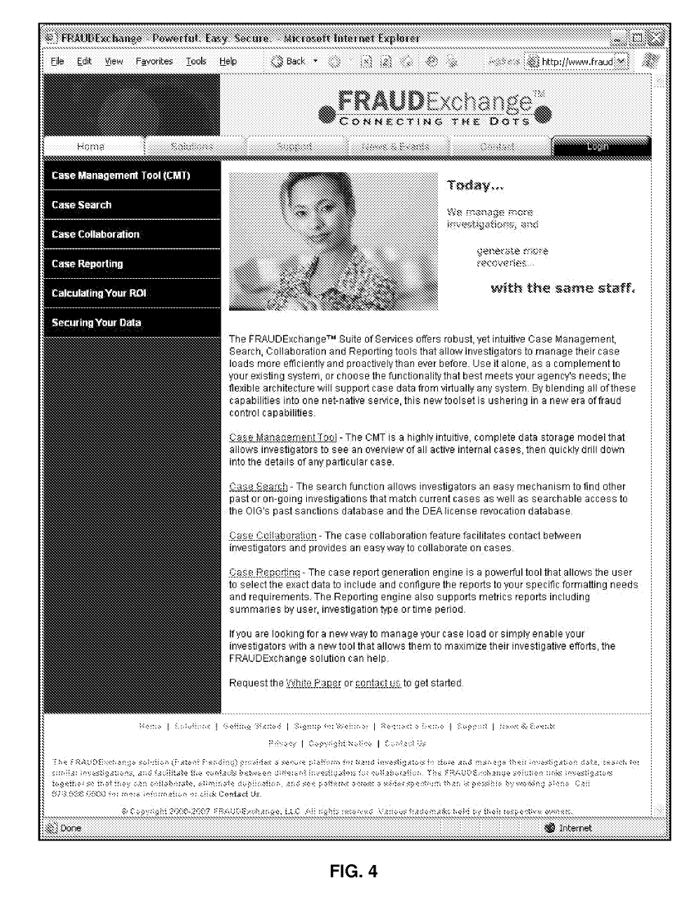

FIG. 4 shows a user interface of the Home page of the system according to one embodiment of the present invention.

The system is accessed via a web browser (Internet Explorer, Firefox, etc.). From this landing page, customers and/or prospects may learn more about the system by navigating through the informational pages.

A current subscriber simply clicks on the Customer Login tab to begin using the system.

For the purpose of illustration of the present invention, only those primary pages that affect system usage are shown below.

### 3.2. Login and Account Creation

### 3.2.1. Login

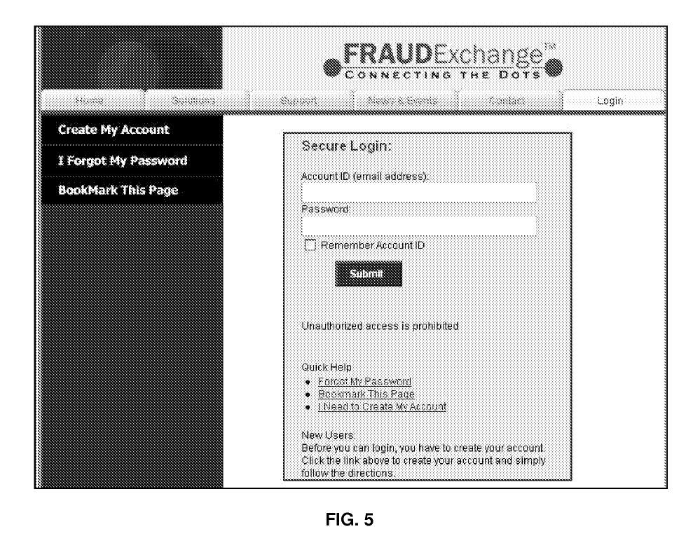

FIG. 5 shows a user interface of the Login page of the system according to one embodiment of the present invention.

For users that have already subscribed and created a user account, they need only enter their user ID (email address) and password then click Login. Once validated, the system takes them to their personal My Dashboard page (see 4.7 below).

For new subscribers, the service administrator creates at least two admin accounts for each entity. These administrators validate the credentials of each investigator that wishes to use the system. Once the admin accounts have been created, they receive an email from the system instructing them to forward an included URL to the investigators and/or users that should have access to the system. The URL directs the users to the Request Account (see 3.2.2 below) web page (a user can also access the Request Account page by clicking the “I Need to Create My Account” link shown above). By using the URL, certain information about the admin will be pre-filled for the user so that it automatically directs the request to the proper person.

By credentialing all users of the system in this way, each entity has the power to control access to the data housed in the system.

### 3.2.2. Request Account

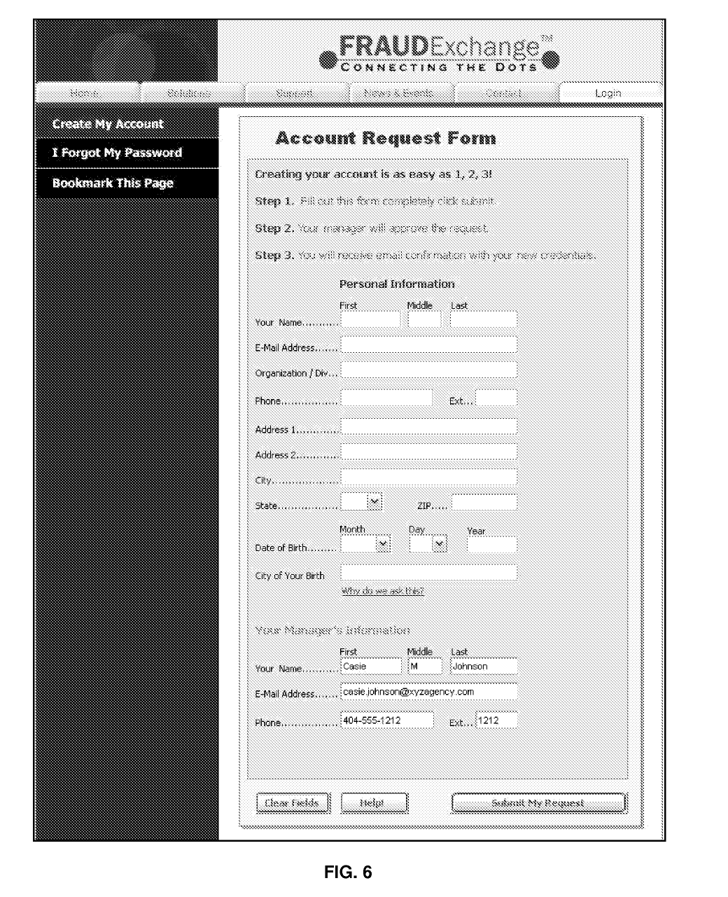

FIG. 6 shows a user interface of the Request Account page of the system according to one embodiment of the present invention.

Each non-admin user requests a new account once. If the user accesses this page via the URL sent by the admin, the Manager's Information will be pre-filled. The user simply enters his/her data in the form and clicks Submit My Request.

The user's data is stored and a notification email is sent to the admin indicating that someone has requested an account. The admin reviews the account request and the credentials submitted (see section 4.4) and determines if the user is valid and has the proper authority to use the system. The admin can also review, suspend and remove accounts in the Account Management area (see section 4.5)

The system also collects at least one piece of personal information (e.g. City of Birth, Mother Maiden Name, First Pet, etc.) which acts as a security marker should the user ever forget his/her password. The information is generally known only by the end user and provides an easy and secure method for verifying the users' identity should they need to change a forgotten password (see section 3.2.3).

### 3.2.3. Change Password

A user may change his/her password at any time or when directed to do so periodically according to the business rules set forth by the service administrator. The user simply enters his/her user ID and old/current password, then enters the new password and re-enters it a second time to confirm typing accuracy. Once entered, the user simply clicks the Change Password button.

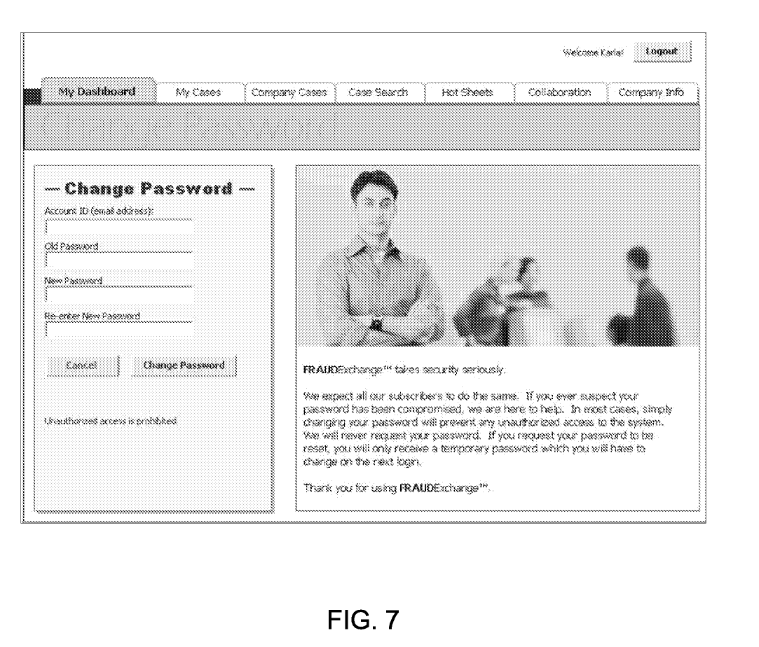

FIG. 7 shows a user interface of the Change Password page of the system according to one embodiment of the present invention.

### 3.2.4. Forgotten Password

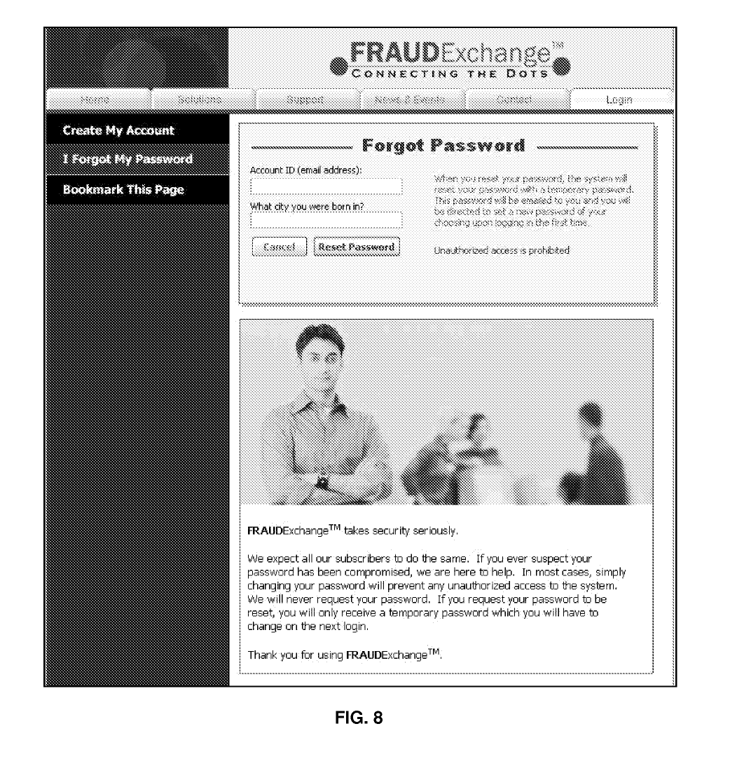

If a user forgets his/her password, he/she clicks on the “Forgot My Password” link on the login page as shown in FIG. 8, which directs them to the Forgotten Password interface. Here, the user has two methods of resetting their password. First, they can enter their Account ID (email address) and then answer the security question; they entered the answer (see section 3.2.2 above) to this question when they requested their account.

If they do not know the answer to the security question, they may click the Email Administrator button which sends a request to their admin to reset their password.

In either case, the system will generate a temporary password, and email this new password to the Account ID email address. Upon the next login, the user will be directed to change the password (mandatory).

### 3.3. Exemplary Terms of Use

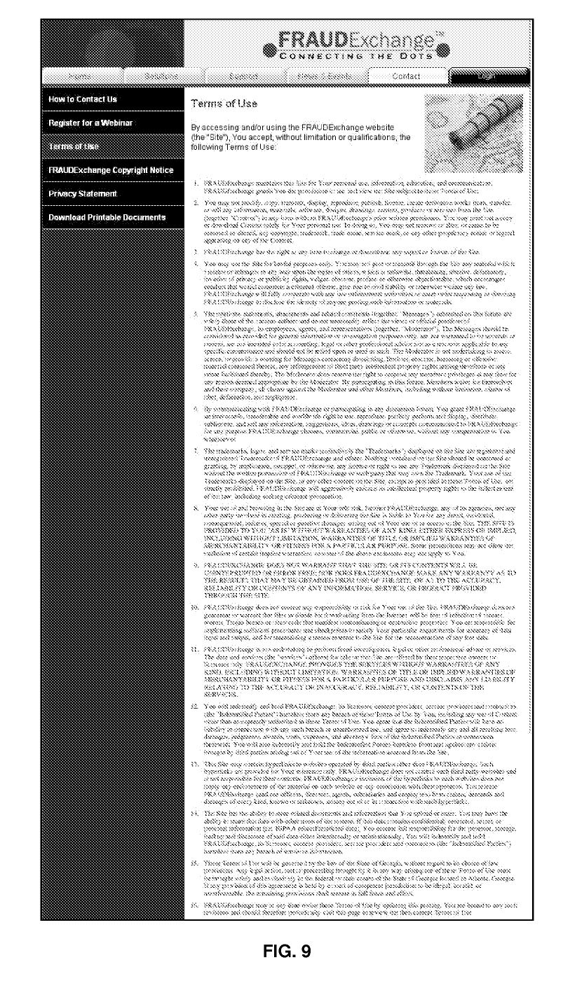

A page of the Exemplary Terms of Use of the system is shown in FIG. 9 according to one embodiment of the present invention.

### 4. Detail System Design—System Administration

### 4.1. Data Accessibility Rules Engine

The system has the capability to set rules regarding which entities are allowed to search/collaborate with each other. This setting is controlled by service administrators (not subscriber administrators or users). When the new account is being added and periodically (as new potential users are added), the subscriber will be asked with which entities they wish to share information (allow their cases to be displayed within the Search Results, etc.). The control allows each subscriber to limit to whom their data is exposed. Some entities may not be able to share with certain entities due to ethical or legal restrictions. This feature allows those with special legal considerations still to make use of the system. A subscriber may actually lock all cases from view—only allowing a one-way view (they can see other cases, but other subscribers are not allowed to view their cases). While this mode of operation is discouraged, there are statutes which force certain entities to utilize this capability, so it is accommodated within the present system.

| Subscriber: | Policy: |
|---|---|
| Entity A | Shares with Any |
| Entity B | Shares with Entity X & Y |
| Entity C | Shares with None |
| . . . | . . . |
| Entity N | . . . |

### 4.2. Administrator Dashboard

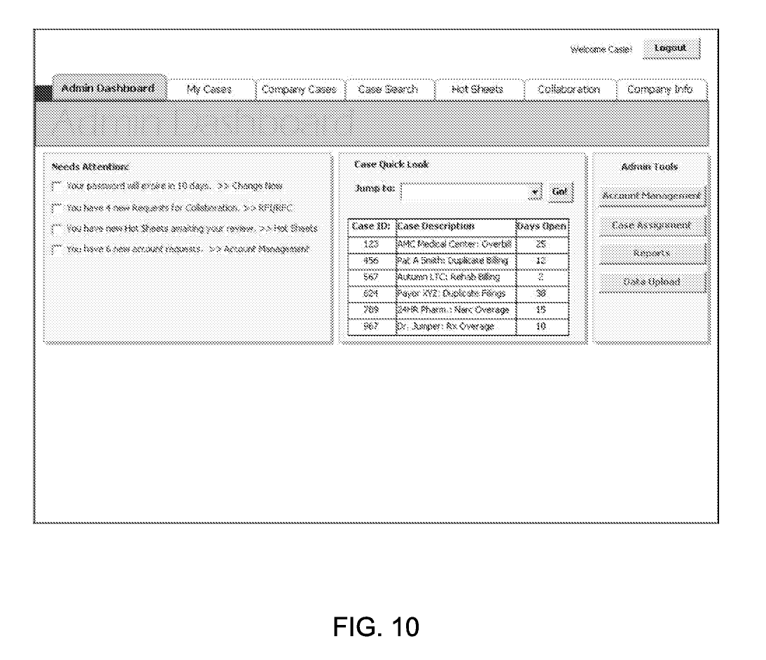

FIG. 10 shows a user interface of the Administrative Dashboard page of the system according to one embodiment of the present invention. The Administrator Dashboard is shown to the subscriber administrator upon login. It is similar to a standard user Dashboard, however, it has a number of administrative tools which are accessible from this page including: Account Management, Case Assignment, Reports, etc.

### 4.3. Administrator Case Assignment

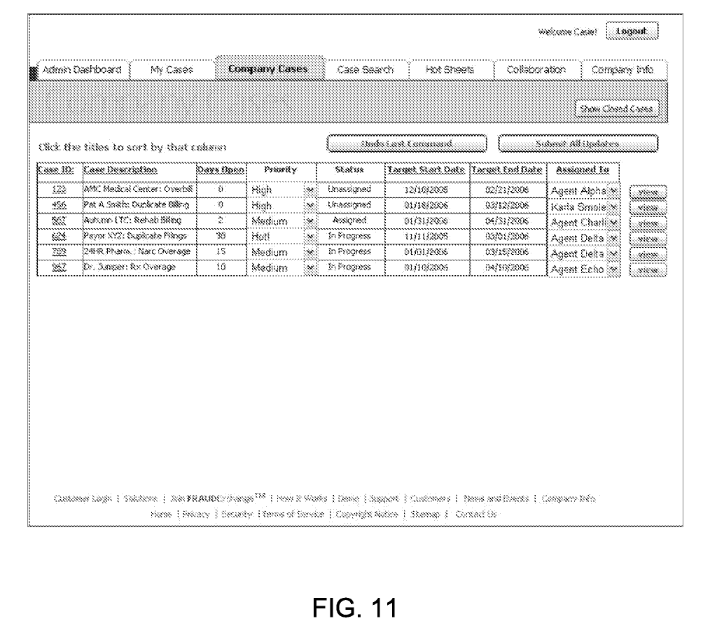

FIG. 11 shows a user interface of the Administrator Case Assignment page of the system according to one embodiment of the present invention. The Case Assignment page allows a subscriber administrator to assign new cases to the various users/investigators within the entire entity. The administrator can also edit case Priority, Due Dates, etc.

### 4.4. Administrator Account Management

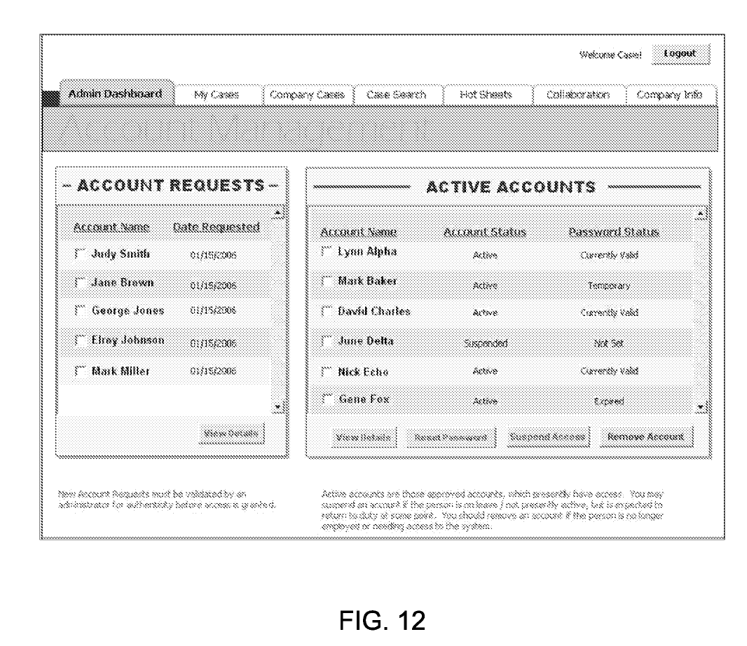

FIG. 12 shows a user interface of the Administrator Account Management page of the system according to one embodiment of the present invention. The Account Management page allows a subscriber administrator to:
Review new account requests (verify credentials prior to granting access to the user);
View and Edit User details;
Reset User passwords;
Suspend Active Accounts (leave of absence, maternity leave, etc.); and
Remove accounts for users who have left the entity, retired, etc.

### 4.5. Existing Account Details and Reporting

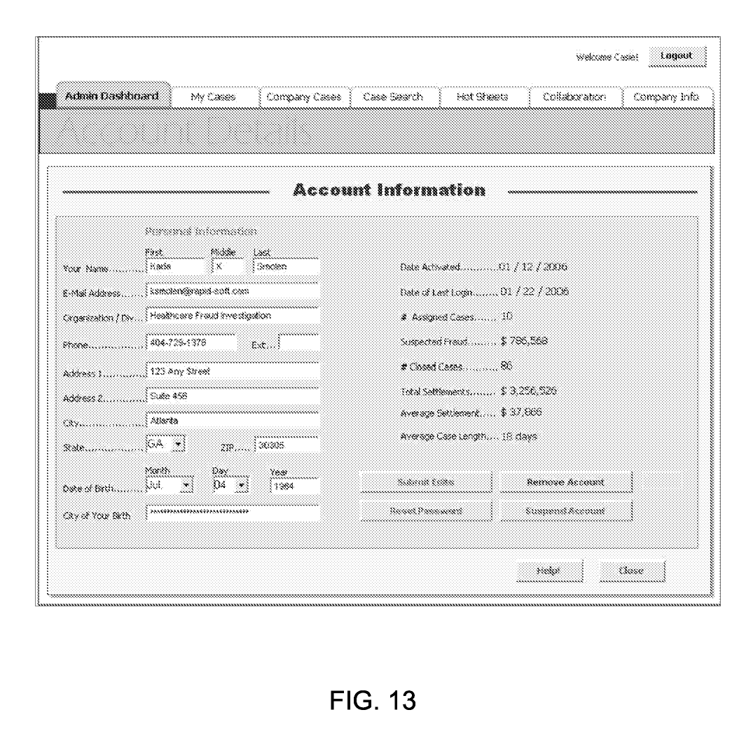

FIG. 13 shows a user interface of the Existing Account Details and Reporting page of the system according to one embodiment of the present invention. The Account Details page allows a subscriber administrator to view/edit a user's credentials, contact information, etc.

It also provides statistics on the user and allows the administrator to perform account maintenance. This is an example of the type of metrics that can be quantified in other user reports in aggregate for all users within an entity. Other reports may be generated or added to the administrative interface to quantify the needed information—as defined by end-users during setup.

### 4.6. Account Details Request

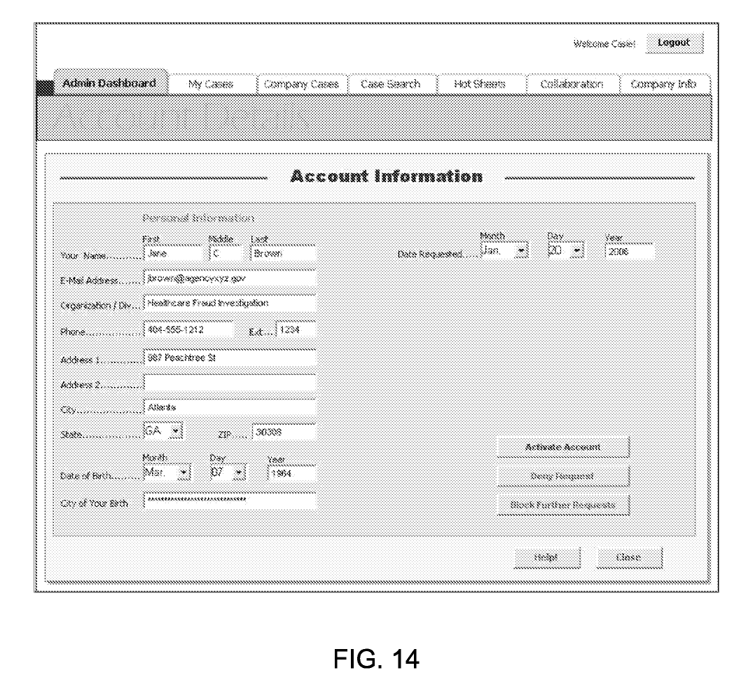

FIG. 14 shows a user interface of the Account Details Request page of the system according to one embodiment of the present invention. When a user requests a new account, the subscriber administrator is notified of the request. Upon login, the administrator is able to view the requestor's credentials and decide if the user is allowed to have an account in the system. If the user request is valid, the administrator clicks the Activate Account button. The system sets a temporary password and sends a notification email to the user (requestor). If the user is not valid, the administrator denies the account, specifies a reason and the system generates a notification message to the user with the reason. If an administrator receives multiple/harassing requests, they are able to block further requests being generated from the particular email address.

### Detail System Design—Standard User Interface

### 4.7. Case Management—My Dashboard

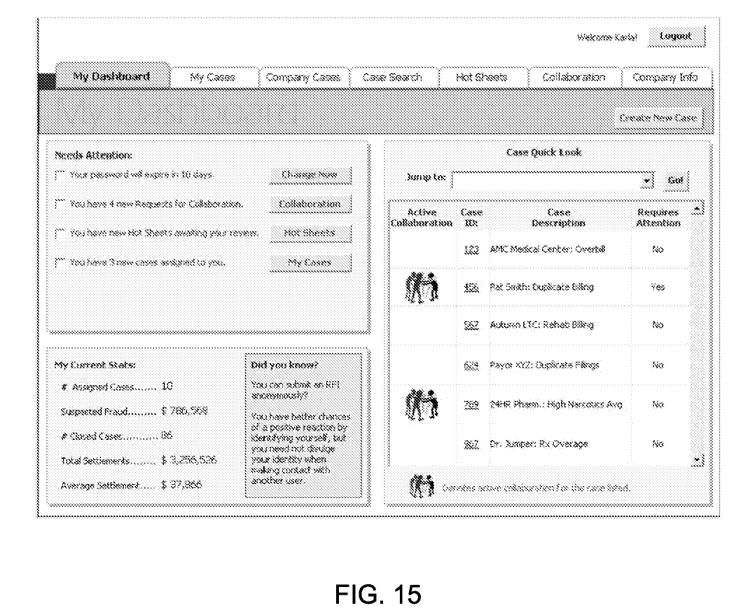

Upon successful login, the user is directed to the My Dashboard, whose user interface is shown in FIG. 15 according to one embodiment of the present invention. The user is shown three main areas including:
Needs Attention—this area informs the user of events or impending events that require attention.
My Current Status—this area shows the user a number of basic metrics on current/past cases.
Case Quick Look—this area shows the user their current cases with abbreviated information.

The user may also navigate to other areas using the tabs across the top:
My Cases—shows the investigator's current case load with more detailed information and metrics.
Company Cases—shows the list of all current cases within the entity.
Case Search—Search interface where the user can enter any criterion for searching.
Hot Sheets—Shows the user any automated search results for their current cases.
Collaboration—This page allows the user to easily review all inbound and outbound requests without having to open each case individually.
Company Info—This page is an informational page showing the entity's administrator and how to contact the service administrator.

The user is also able to click the “Create New Case” button to enter and create a new investigation. This button directs the user to a case creation “wizard” interface (see section 4.8).

### 4.8. Create New Case

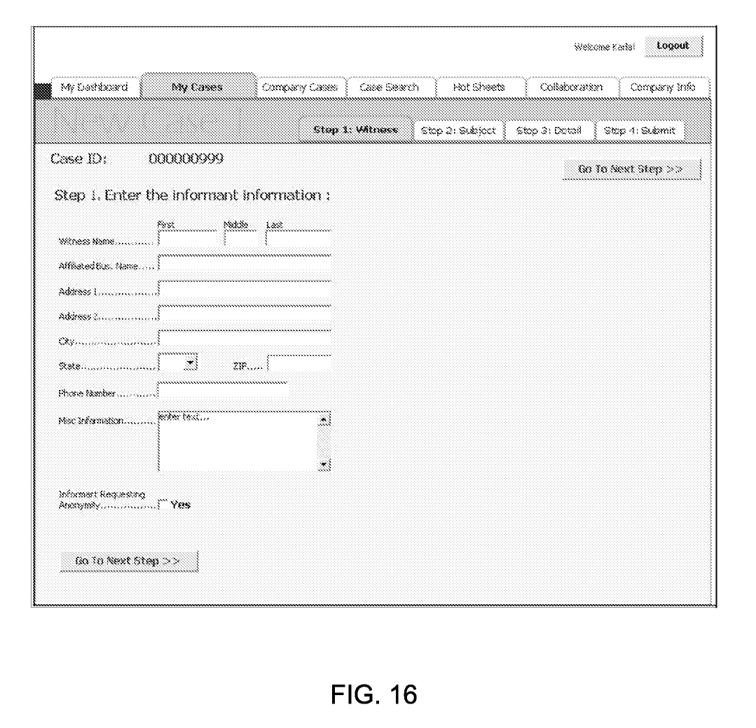

FIGS. 16-19 show a user interface of the New Case Creation wizard pages 1-4, respectively, of the system according to one embodiment of the present invention. There are three ways a case is created in the system:

(1). A case is imported from the subscriber's existing system,

(2). A Placeholder Case is created after performing a search, and

(3). The user creates a new case using the system's Create New Case tool.

From the Dashboard or My Cases, the user clicks the Create New Case button which directs them into the New Case interface. This interface includes four guided steps that route the user through all the critical data collection pages. The first step is the Witness (or informant) area, second is the Subject (or suspect) area, third is the Detail (or allegations/evidence) area, and the fourth step allows the user to go back, review entries, and submit the case.

The system allows the user to identify the informant, yet classify the data as confidential if appropriate (e.g., if the informant wishes to remain anonymous (and the appropriate box is checked)—his identity will not be revealed to others).

The system has the ability to identify certain entries in the Detail area as “sensitive or regulated data”. Certain data that is collected may be subject to HIPAA regulations and therefore, it needs to be treated differently from other data.

The system allows the user to classify a new case either as an “Investigative Case” or “Tip”. Tips are cases that are not yet being investigated. Often, a report may be made that lacks sufficient evidence to warrant an investigation. However, these reports/tips require monitoring and if more evidence becomes available, the classification may be changed to “Investigative Case”.

Once satisfied with all entries, the user clicks the Submit New Case button to add the case to the system.

### 4.9. My Cases

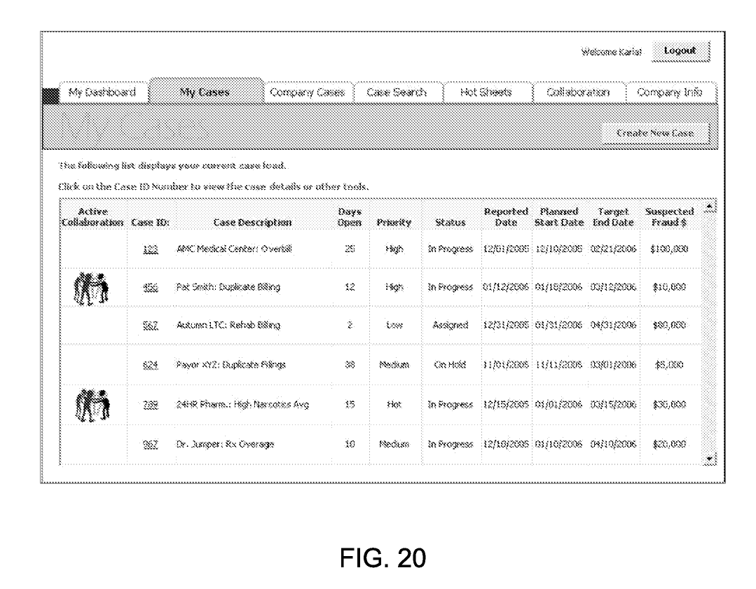

FIG. 20 shows a user interface of the My Case page of the system according to one embodiment of the present invention. The user views their current case load by clicking the My Cases tab. Here they see which cases have active collaboration, the priority of each case, critical dates, and the amount of the suspected fraud for each case. The user clicks on a case number to view the details for a particular case or open the case for editing, etc.

For exemplary purposes and for the discussion that follows, the user has “selected” case number 456 for viewing of details and/or to add further data (see below).

### 4.10. Case Detail

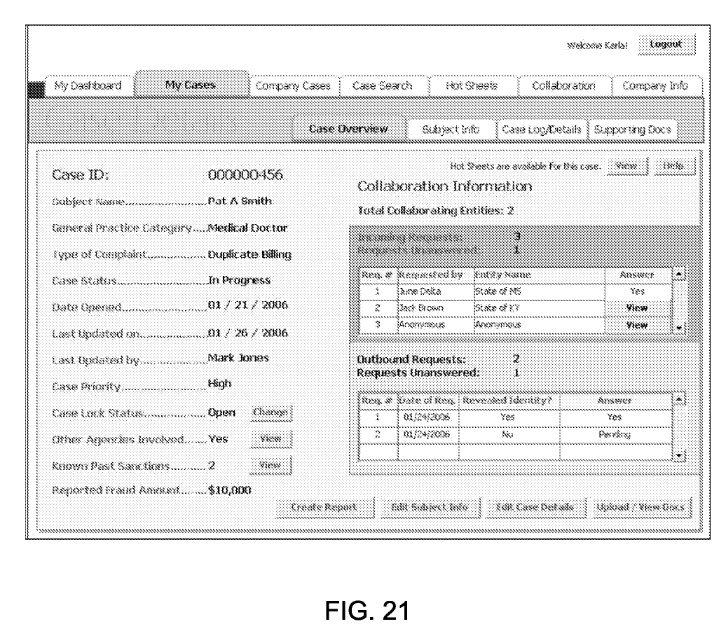

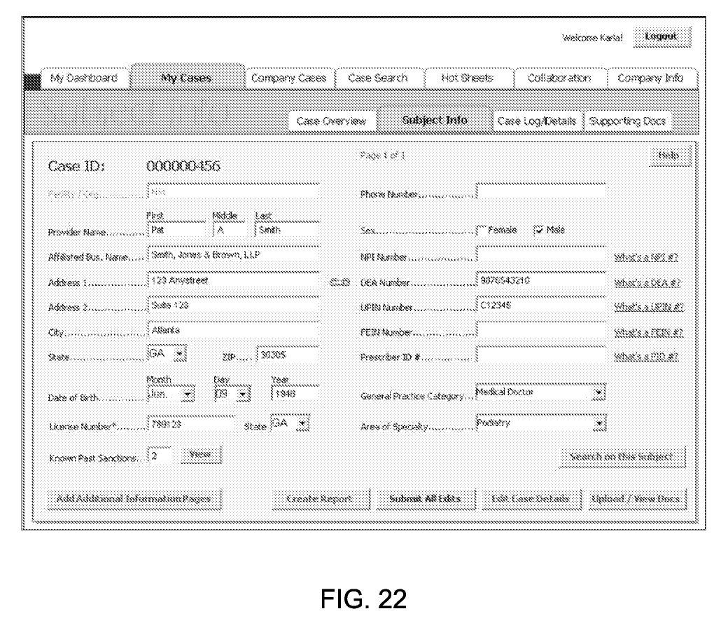

FIG. 21 shows a user interface of the Case Detail page of the system according to one embodiment of the present invention. As shown, the user is viewing Case ID: 456. This page allows the user a more in-depth view of the case status and collaboration. Other pages are available for managing case information via the tabs on the Case Details bar. By clicking any of these tabs, the user has quick access to detailed information on the Subject (who/what is being investigated), the Case Log (details about the investigation, other parties involved and evidence collected), and Supporting Docs (the area to collect and manage any digital files that may be used to support the case)—for more information on each of these areas, see the following pages.

In the collaboration section of this page, the user can see the status of any requests he/she has sent or received. If new requests have been received, the user simply clicks the view button for each to see the message and decide if he/she wishes to collaborate with the requester.

If Hot Sheets (see section 6.3 for more information) are available for this case, a notification will be shown at the top of this page with a “View” button that will take the user directly to the Hot Sheets interface.

The system also contains data from the MED/OIG and DEA on sanctions and license revocations. If there is data available from any of those databases, the system indicates this and allows the user to view those sanctions directly (see section 4.16 for more information below).

A user may also wish to create a report on this case for paper or electronic filing needs. By clicking the Create Report button, the user quickly and easily creates a report with some or all of the information held in the system (see section 5.1 for more information the Case Reporting tool).

### 4.11. Subject Info

FIG. 22 shows a user interface of the Subject Info page of the system according to one embodiment of the present invention. The Subject Info tab allows a user to view, enter or edit data about the Subject of the investigation. The Subject can be a person, facility, or organization. Often doctors operate from multiple offices and even in multiple states under various licenses and identification numbers. The system supports entering multiple pages of information for one person, etc. by clicking the Add Additional Information Pages button.

The user may also wish to search for this Subject using some or all of the information contained in the page shown. To do so, the user simply clicks the Search on this Subject button which will load any searchable data from the Subject page to the Search interface. From the Search interface (see section 6), the user may alter, add or delete search terms prior to submitting the search.

Again, the user may navigate to other pages about this case, create reports or view past sanctions.

### 4.12. Case Log

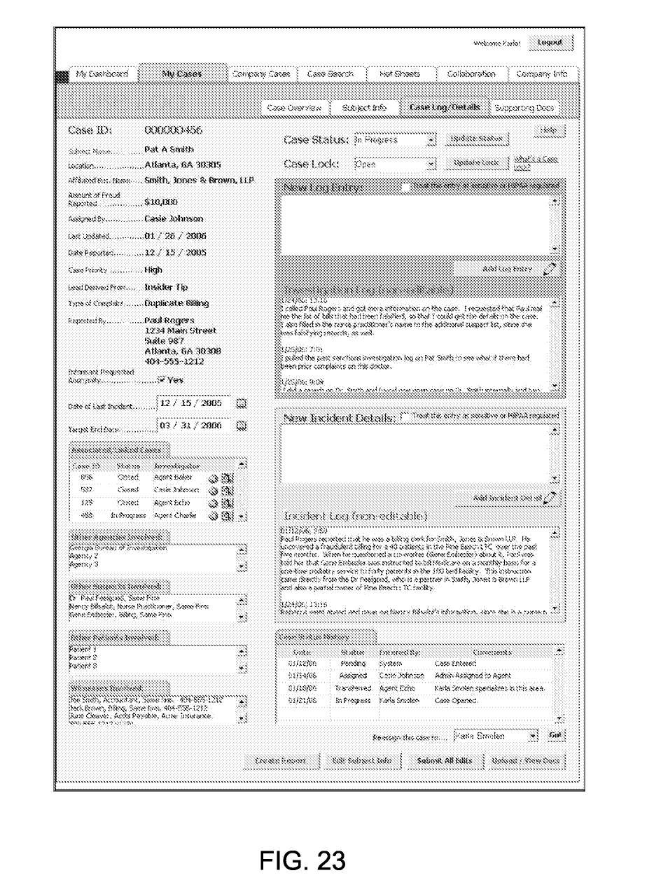

FIG. 23 shows a user interface of the Case Log page of the system according to one embodiment of the present invention. The Case Log is used by investigators to capture evidence, notes, and related information to the case. The Case Log also shows the Case Status History, which acts an Audit Log for all actions on the case. Every time an edit or search is conducted, the Audit Log receives a new entry by the system automatically. The Audit Log is not editable and is used to track any actions within the system for each case. The Case Log also contains a number of free-text entry areas for the investigator to enter pertinent data. The Investigation Log can be thought of as the investigator's “notepad” where he/she can enter any comments, thoughts, and actions taken during the investigation. The Incident Details section is for specific data collected from witnesses or informants pertaining to the case. Once entered, the data is non-editable—this is for the purpose of creating and maintaining an accurate historical perspective of the data. The investigator may enter a new corrected entry, but the past entries remain in the system to preserve the integrity of the investigation and prevent evidence tampering. The system has the ability to identify certain entries in the Detail area as “sensitive or regulated data”. Certain data that is collected may be subject to HIPAA regulations and, therefore, needs to be treated differently from other data.

This area also contains a tool which allows the investigator to link other past or present cases (e.g. bookmarks to other internal cases). Often, past cases help determine various patterns and can show historical references to the same behaviors over time. This tool allows the user a simple way to open and view those cases when needed without having to remember specific case IDs, etc.

The investigator can alter the case status as needed during the course of the investigation. For example, the case may be put on hold, or transferred to another agency. The case may also be closed when complete (see section 4.14 below on Case Disposition).

A case may be locked by the investigator. There are two modes available for locking a case. First, a case may be “Closed to RFI's.” This mode allows other users to search on and see that an investigation is ongoing, but it will not allow them to request collaboration. Often, as a case approaches its final stages or nears a court hearing, further collaboration from outside entities would not be useful or even allowed. By using this mode, the investigator is still allowing other entities to know that a case exists, but it is simply “off limits” at this time. Once the case is closed, the case may be unlocked and the data is available for use by other entities, for example, in proving past histories, etc. The second method of locking a case is “Locked (Hidden).” This mode prevents the case from being shown in any search result and therefore, no RFI's would ever be possible. The case will simply never show up to any other user doing a search. In most cases, users within an entity are still be able to see any cases within the same entity when viewing Company Cases (see section 4.17), but it would not show up in search results because of the Case Lock.

The investigator may reassign the case to another investigator within the same entity. Often, an investigator may specialize in a particular area of criminal behavior, technical expertise or simply be more geographically applicable. The current investigator simply selects which investigator to transfer the case to, and clicks the “Go!” button. The investigator will be prompted to enter a reason for the transfer and a notification message will be sent to the entity admin as a courtesy and integrity check.

### 4.13. Case Reassigned

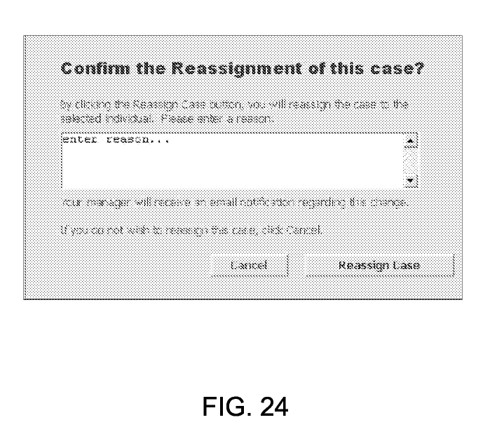

A case can be reassigned to a selected individual. FIG. 24 shows a user interface of the Case Reassigned page of the system according to one embodiment of the present invention.

### 4.14. Case Disposition

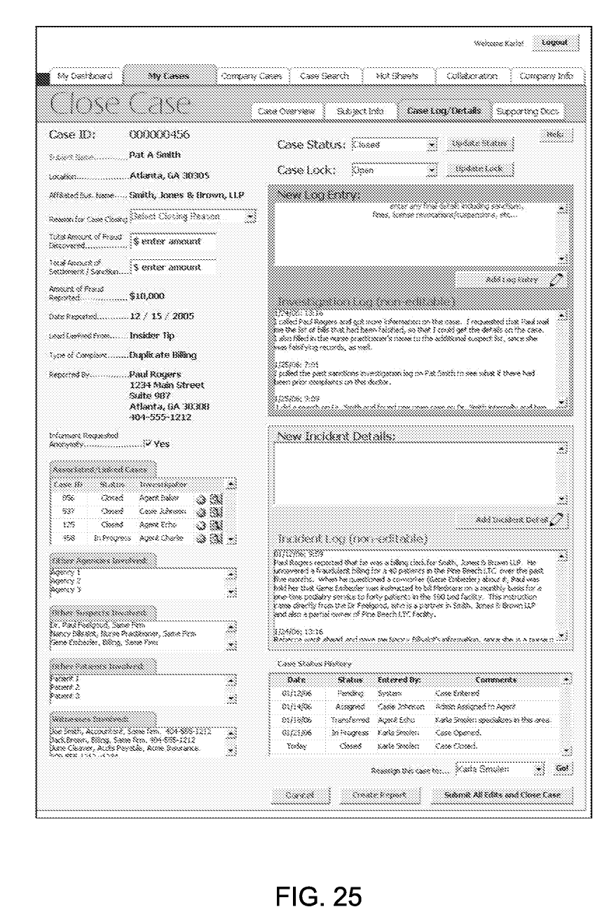

FIG. 25 shows a user interface of the Case Disposition page of the system according to one embodiment of the present invention. When a case is finished, the user changes the case status to Closed. In doing so, the system prompts the user to make final disposition entries regarding the outcome of the investigation. After making the final edits, the user clicks the Submit All Edits and Close Case button. The case is closed, and removed from the user's current case load list.

### 4.15. Supporting Docs

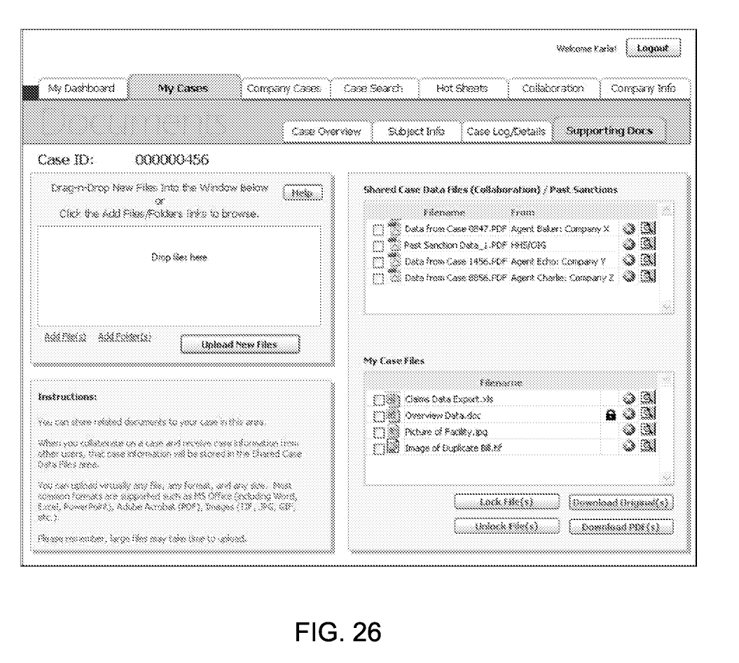

FIG. 26 shows a user interface of the Supporting Docs page of the system according to one embodiment of the present invention. The system allows users to store other supporting, digital documents related to the case. There are two main categories for these documents including:
(1). Collaborative Data generated by the system stored as PDF. This data is considered Read Only data and is not editable within the system, and
(2). Other Case Files that are collected by the investigator and loaded into the system. These files are the property of the investigating entity and are not controlled by the system except where the user wishes to lock a file to prevent others from viewing, editing or downloading.

Any of the files may be included as supporting evidence to a case report (see section 5.1 on Case Reporting).

To upload files to the Supporting Docs page, a user simply drags and drops files onto the Upload Landing Area and clicks the Upload New Files button. The files are processed and listed in the My Case Files area. Alternatively, the user clicks the Add File(s)/Folder(s) button, browses to the content for upload, selects it, and clicks the Open button; the content is listed in the Upload Landing Area and the user then merely needs to click the Upload New Files button.

Collaborative content comes from other investigators, other past/present internal cases, or Past Sanction listings. This content is generated and time-stamped in a PDF file and stored in the Collaborative Content Area. The system provides a mechanism to prevent content from other entities from being shared or forwarded as part of collaboration.

### 4.16. Past Sanctions

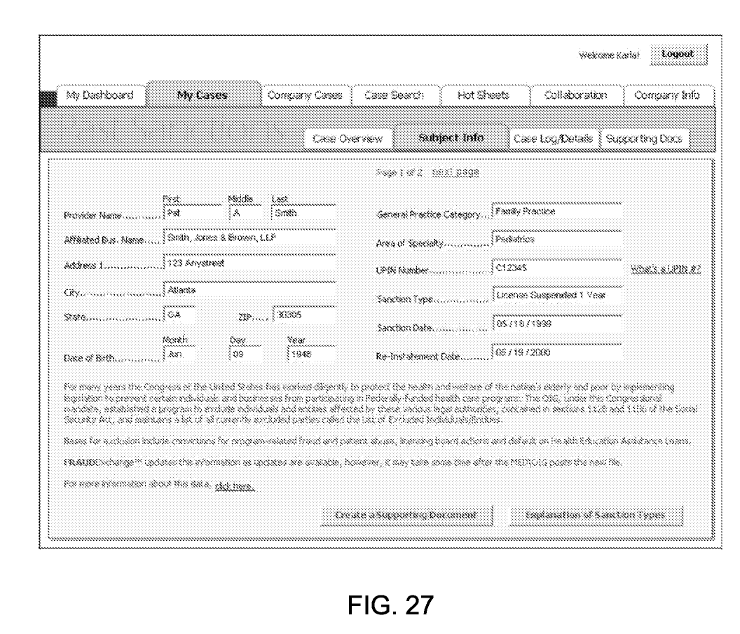

FIG. 27 shows a user interface of the Past Sanctions page of the system according to one embodiment of the present invention. The system also contains data from the MED/OIG and DEA on sanctions and license revocations. If there is data available from any of those databases, the system indicates its presence and allows the user to view those sanctions directly.

The page above depicts a past sanction from the MED/OIG database. This data can be used to detect patterns and past behaviors.

### 4.17. Company Cases

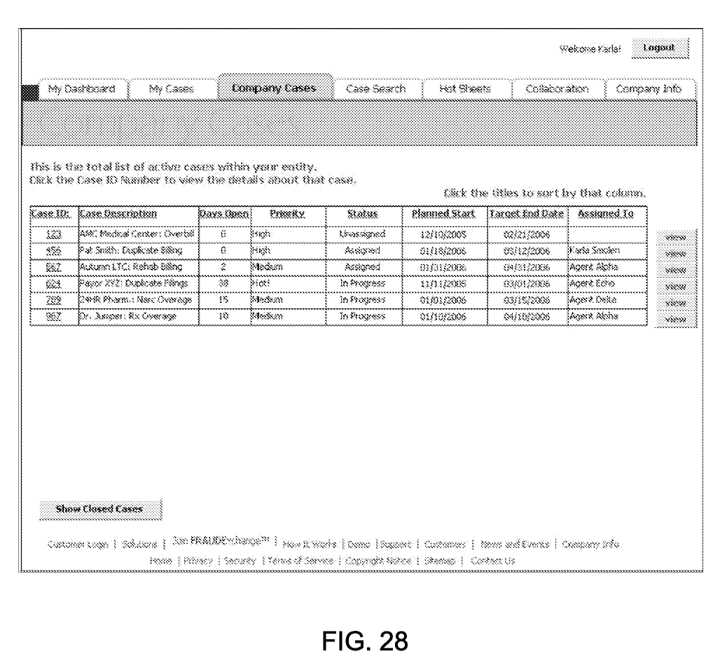

FIG. 28 shows a user interface of the Company Cases page of the system according to one embodiment of the present invention. A user views all the cases within his/her own entity by clicking on the Company Cases tab. All cases (except past closed cases) are show here. By clicking the Show Closed Cases button, the user may see past cases (see section 5.2 below for more information on viewing closed case details).

### 4.18. Company Case Detail

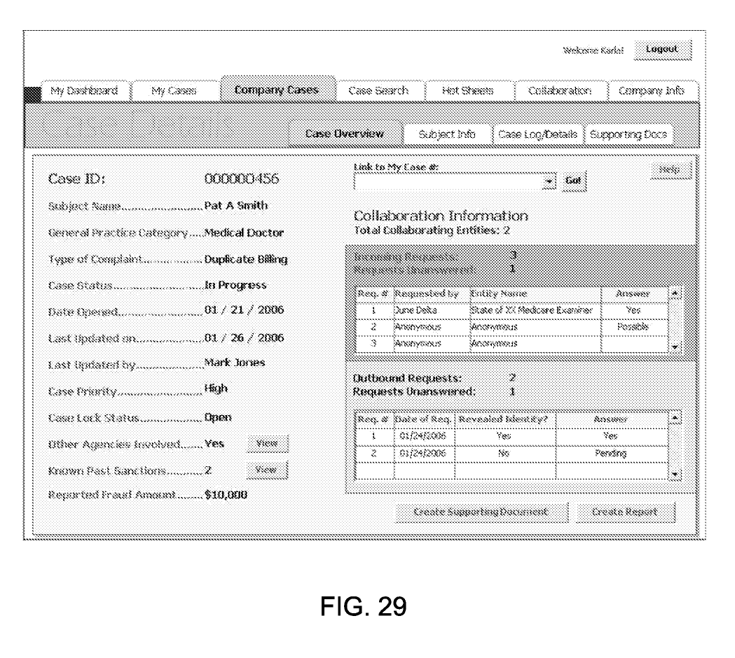

FIG. 29 shows a user interface of the Company Case Detail page of the system according to one embodiment of the present invention. A Company Case is an on-going/current case that is being managed by another investigator within the same entity. Any authorized entity can view other Company Cases, however, he/she is not permitted to edit or add to the case. He/she is allowed to create links to his/her own cases, create supporting documents (reports stored as Supporting Docs), or create actual Reports (court filings, required paper filings, etc.).

### 5. Detail System Design—Reporting

Reporting is used to support the following areas/situations:
To create a report on a case for court filing,
To create a report for internal use, interim/status reporting needs,
To create a collaboration document that is shared with another subscriber entity, and
To report on standard investigation metrics (how many cases, close rates, etc.).

This list above is exemplary only of some of the uses envisioned, but it is not exhaustive of all anticipated uses.

### 5.1. Case Reporting and Collaborative Report Creation

When creating a report, information is channeled from the various data points in the database. The user simply selects which data is to be included within the case report by placing a tic (or otherwise selecting) in each corresponding checkbox. The system then assembles the data into one comprehensive PDF document that is time-stamped and locked for authenticity. The resulting report is stored within the system, downloaded or sent to other investigators using the system. When the report is being used as collaborative information, the system automatically routes the file to the requesting investigator's case under the case's Supporting Docs Collaborative Data area.

To maintain a complete audit history, a copy of any collaborative report is stored in both the originator's case as well as the requestor's case area.

Once a report is generated (see below), the user is able to review the resulting file prior to sending it out as a collaborative document. If the report is not satisfactory, the user is able to go back to alter the contents and generate another file. If the user is satisfied, he/she simply clicks the Close & Send button. A user need not wait for the file to be generated—he may simply close the window while the file is being generated and the final file is stored in the respective originator/recipient's areas.

### 5.1.1. Create Case Report

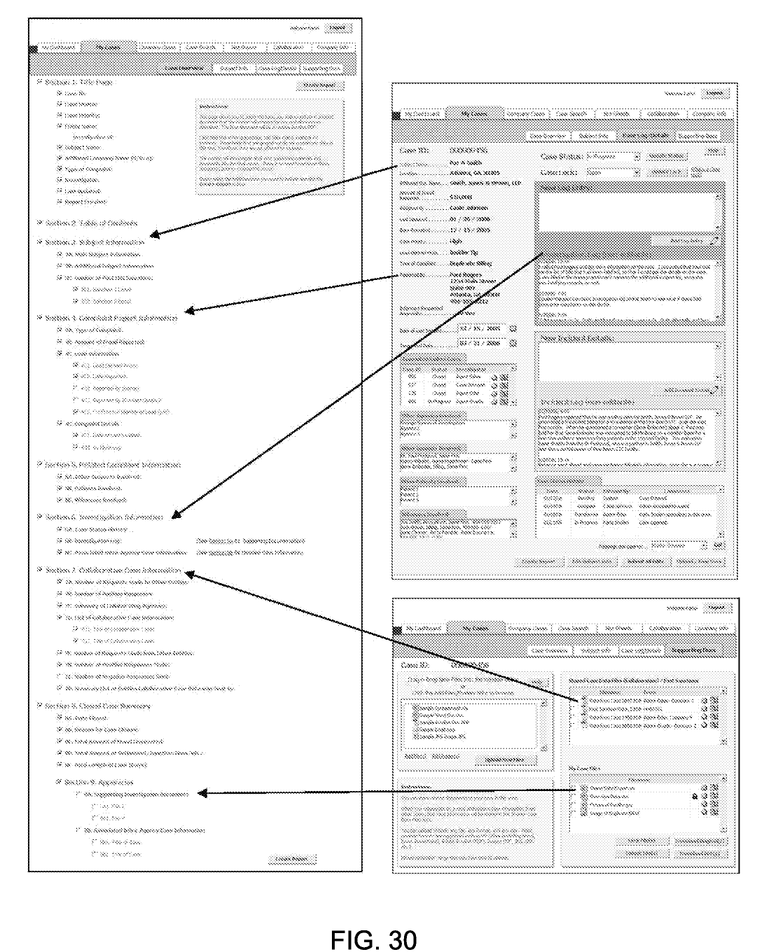

FIG. 30 shows a user interface of the Create Case Report page of the system according to one embodiment of the present invention. On the left is the user interface showing how a user may select various data from the case for inclusion in the report to be created. Below are two pages showing where the data originates within the case management system.

### 5.1.2. Report is Being Generated

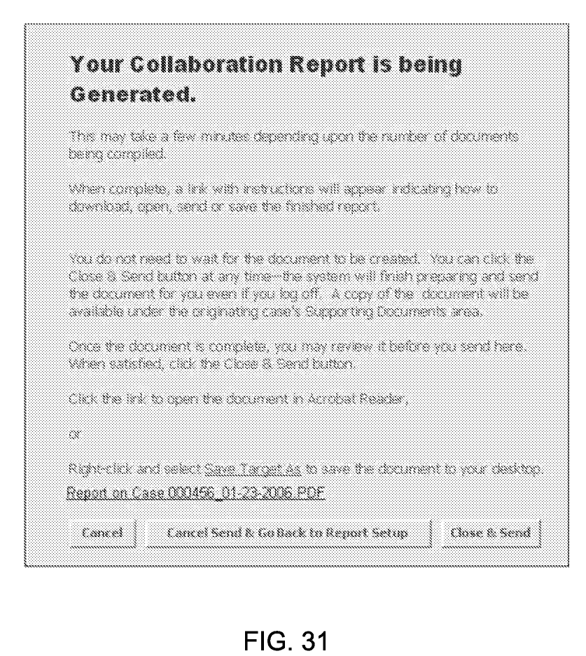

A confirmation page of which the Report is being generated is shown in FIG. 31 according to one embodiment of the present invention.

### 5.2. Closed Case Detail

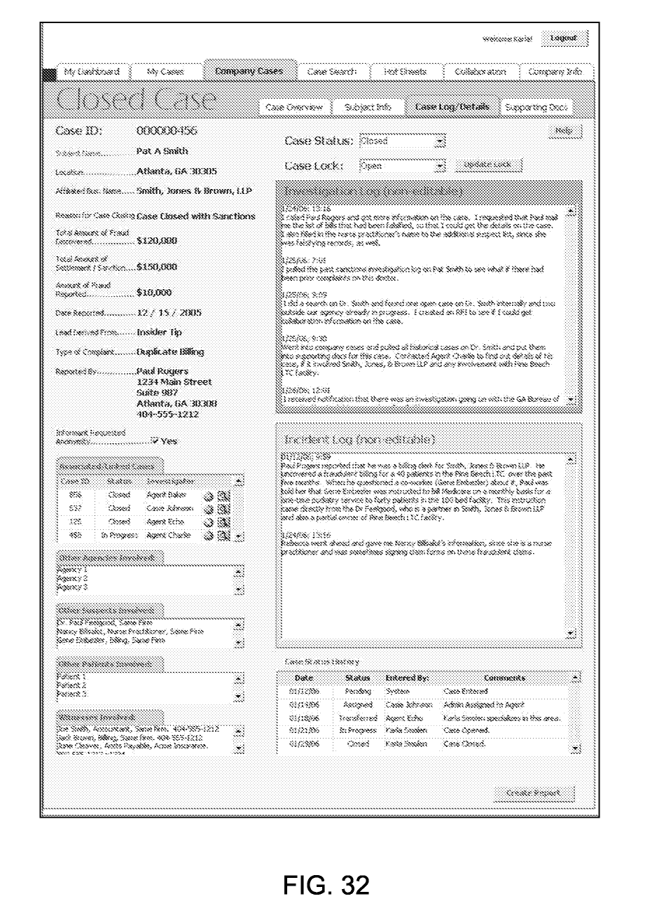

FIG. 32 shows a user interface of the Closed Case Detail page of the system according to one embodiment of the present invention. Users may view closed cases using the same tools and views as a current case. However, the case is locked to edits except for changing the Case Lock status, which affects the ability of other users to search on this case. Users also create reports or create links (bookmarks) from a closed case to support their own current case.

### 5.3. Metrics Reporting

Metrics reporting is used to tabulate performance metrics on the overall usage of the system. The reports can be generated at various levels including Administrator, Director and Manager as examples. Each level tabulates results on the people and their usage of the system for which they are responsible. For example, a Manager may need to generate reports on the results of the five people he/she has reporting to him. The Director however, may need to tabulate and aggregate all reports for all managers reporting to her. An Administrator may be more interested in determining the usage of the system overall and computing the system's ROI based on how the system is being used by all persons within an entity. The Administrator would also receive security notifications for those automated notifications that are generated which indicate suspicious usage of the system.

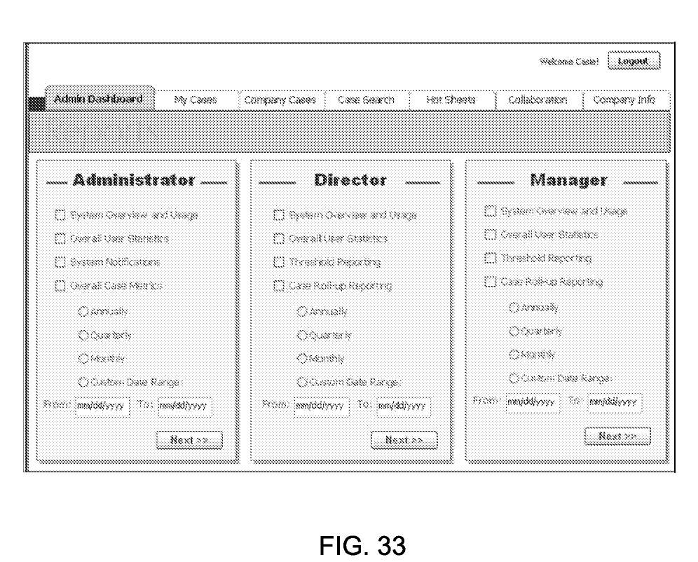

FIG. 33 shows a user interface of the Reporting page of the system according to one embodiment of the present invention

### Detail System Design—Searching

### 5.4. Case Search

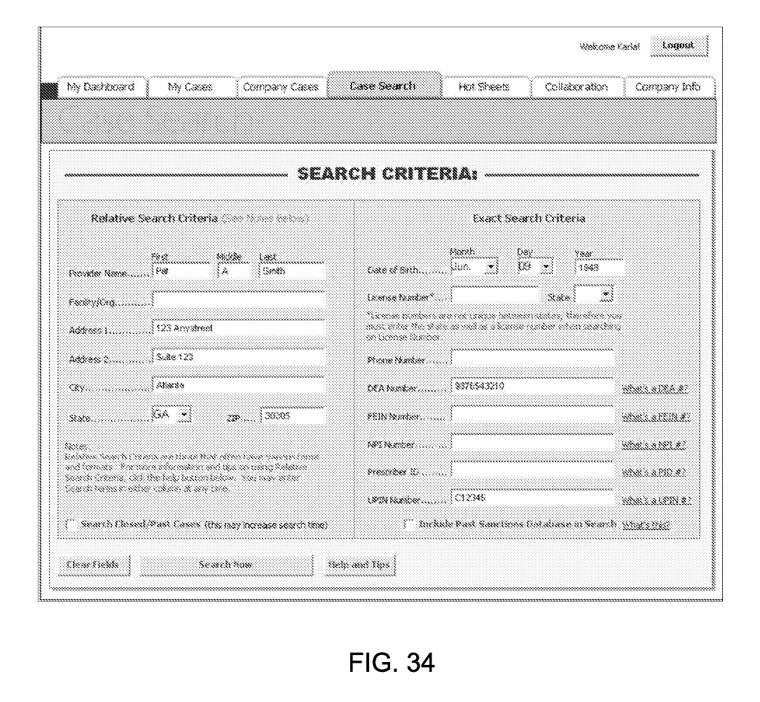

FIG. 34 shows a user interface of the Case Search page of the system according to one embodiment of the present invention. The Case Search tool is accessed by clicking the Case Search tab. Case Search can also be accessed by clicking the Search on this Subject button from the Subject Info tab from any case within the system; when using this method, the criteria will automatically be filled in for the user from the Subject Info page.

A user may enter any number of criteria. Certain criteria require other complementary criteria to be entered; for example, one may not simply enter a zip code and search—more data is required and the system will prompt the user when insufficient data has been entered.

The user optionally searches on closed cases and other OIG/DEA past sanction databases by placing a tic in the appropriate checkboxes in the interface.

There is another form of automated searching called Hot Sheets. For detailed description, see section 6.3 below.

### 5.5. Search Results

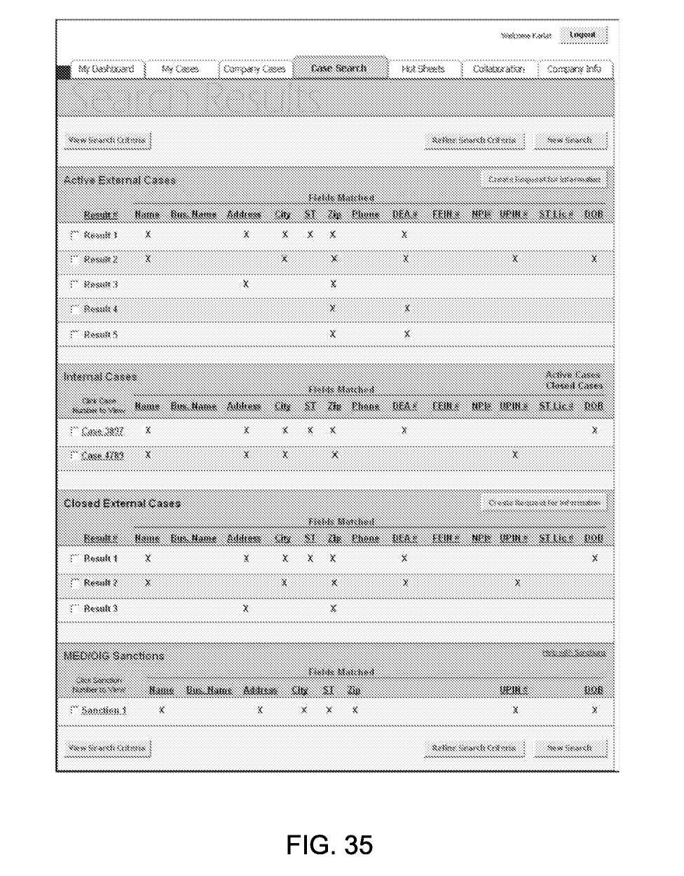

The Search Results are categorized by the area from which the match occurred. The categories include: External Active Cases, Internal Cases, Closed External Cases, and Past Sanction Databases. Users view the Search criteria used, modify the search criteria, conduct a different search, view internal cases or sanctions, or create new Requests for Information (RFIs) from one or more results. FIG. 35 shows a user interface of the Search Result page of the system according to one embodiment of the present invention.

There are two key differentiators when showing search results:

First, each result shows which criteria generate matches and allows the end user to discern the strength and validity of the search result. An “X” indicates that a match occurred within that search field. The more matches, the stronger/more valid the search result.

The system is also able to indicate where a partial match occurs—which is often common in the Name or Address fields. A different indicator (“P”) is used to indicate partial matches.

Second, the search results only indicate if another case exists on the subject in question. The results do not divulge the identity of the investigating party (except where intra-entity cases exist). The results also do not divulge any other information about the matching search result. Only the “owner” of the other case may divulge/share data with another party. The system does not automatically show another case and its details to an outside entity.

### 5.6. Hot Sheets

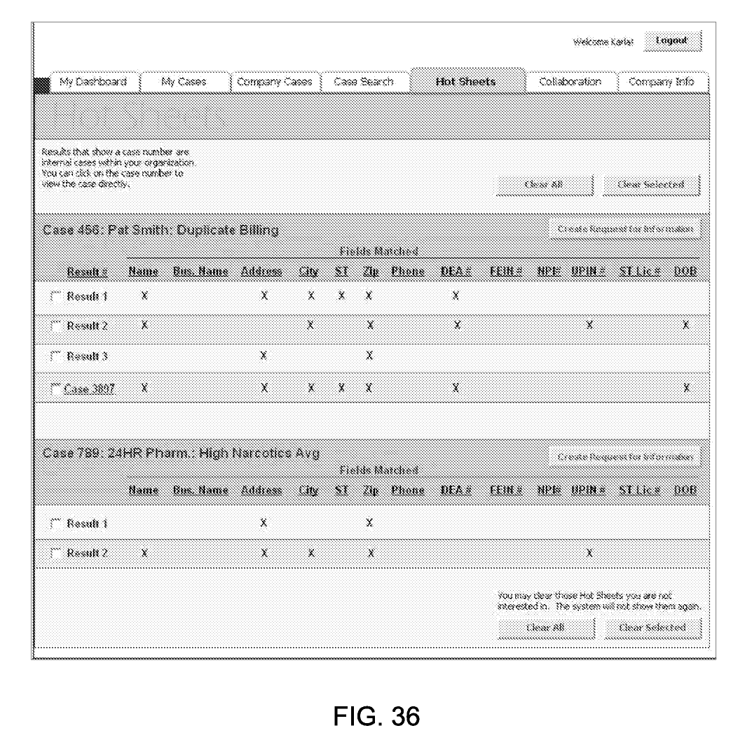

Hot Sheets represent the second form of search results that are possible in the system. FIG. 36 shows a user interface of the Hot Sheet page of the system according to one embodiment of the present invention. As new cases are entered into the system, an automated search is performed on all searchable fields. If any matches occur, each case owner is notified and the results are shown in the Hot Sheets area of the interface. The Hot Sheets results are listed for each case that an investigator is assigned to.

A user may simply view the Hot Sheets and decide whether or not to generate an RFI (see Section 7.3) to other investigators.

### 6. Detail System Design—Collaboration

### 6.1. Collaboration Page

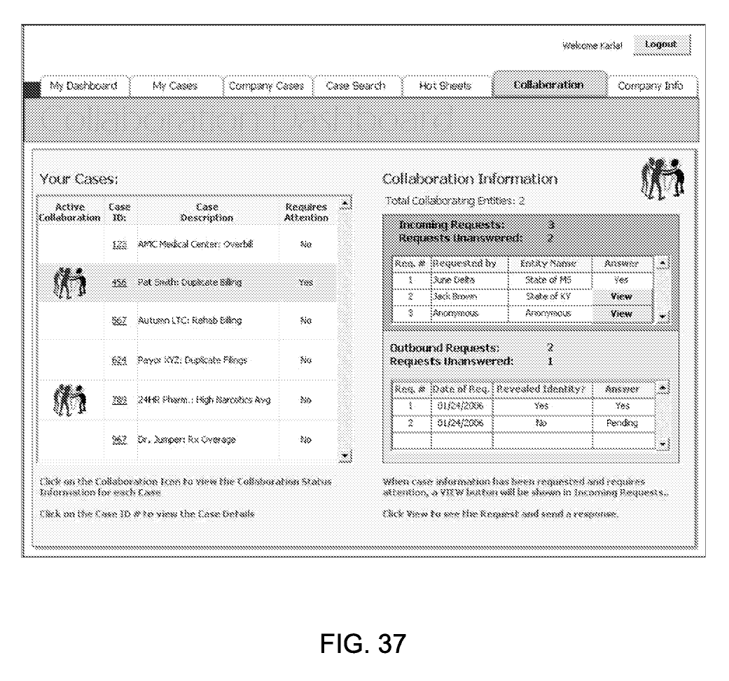

FIG. 37 shows a user interface of the Collaboration page of the system according to one embodiment of the present invention. The Collaboration interface allows users to quickly view the status of all incoming and outbound RFIs by case. If there are new inbound requests, the case will be shown as “Requiring Attention” and the user may review the requests by clicking the View button for each request. Here, the user can view the request from Jack Brown by clicking the View button corresponding to Jack's Request—(see Section 7.2 below).

### 6.2. View Request—Send Response

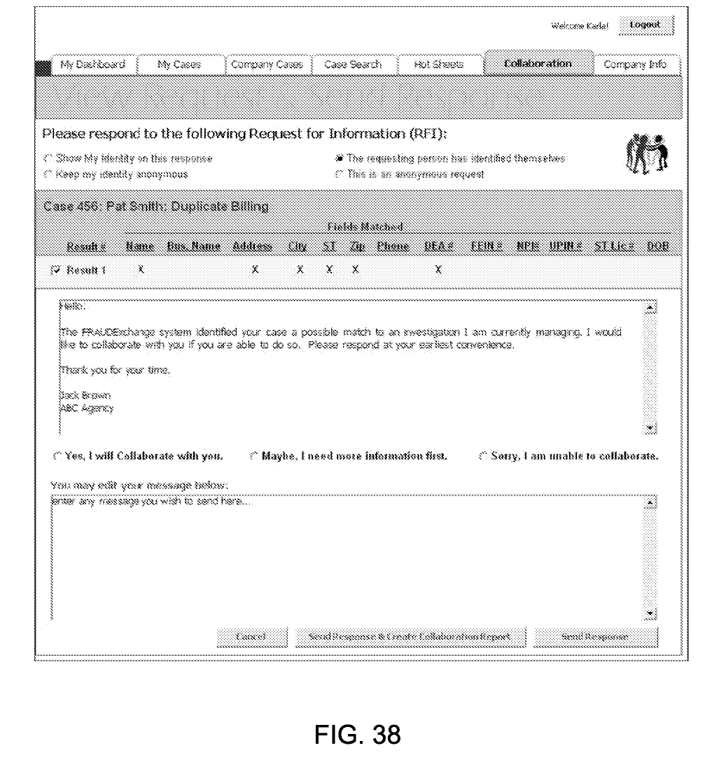

FIG. 38 shows a user interface of the View Request page of the system according to one embodiment of the present invention. A user can view and respond to an RFI in one simple interface. The Request is shown with the corresponding case being identified. The user is also shown the search results from which the requesting party made the decision to submit a request. In this way, the receiving party can evaluate how much data actually matches prior to rendering a decision on whether or not collaboration will be beneficial. The responding party may decline or ask for more information prior to providing collaborative information. The system acts as the conduit between the investigators until formal contact is initiated (which is possible by using the system—the users may choose to identify themselves and request direct contact such as email or phone calls).

The user also has the option of replying anonymously and providing a message with the response. It may be necessary for an investigator not to divulge her name or entity, but provide a message to the other requesting investigators.

### 6.3. Request from Hot Sheet

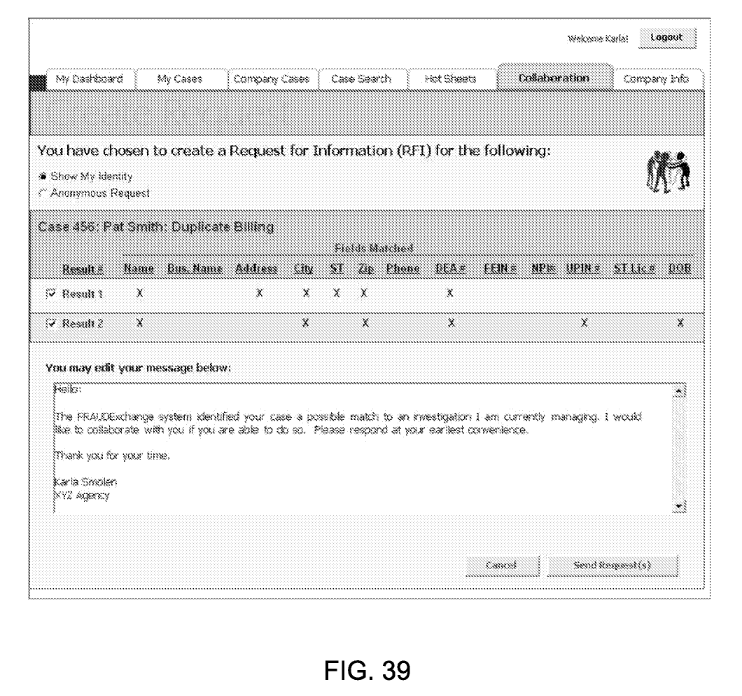

If a Hot Sheet is available, the user generates an RFI directly from the search results posted. FIG. 39 shows a user interface of the Request from Hot Sheet page of the system according to one embodiment of the present invention. When creating the request, the user has the option of divulging his/her identity or remaining anonymous. The user may also select those Hot Sheet results which he/she believes are the best matches to his/her case. The user also has the option of editing a message to the other investigating parties. The requests will automatically be logged in the Collaboration area of the originating case for both parties (sending and receiving).

### 6.4. Request from Search

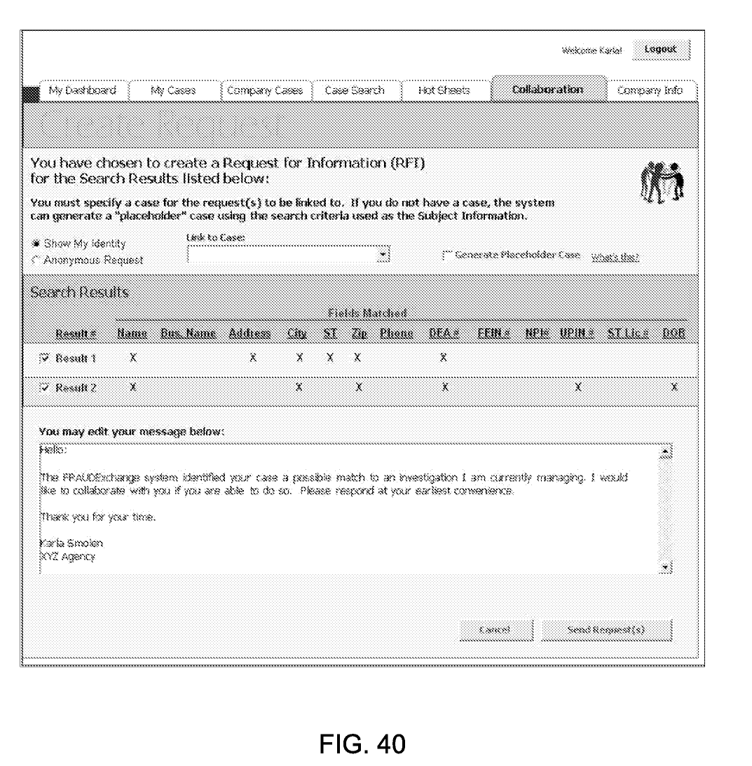

After performing a Search and viewing the Search Results (see section 6.2), the user may choose to generate an RFI to other investigators to request collaboration on the cases. FIG. 40 shows a user interface of the Request from Search page of the system according to one embodiment of the present invention. A user may generate multiple requests for a specific case at one time. Again, the user has the ability to generate the request anonymously or not.

When generating a request from a Search Result, the user specifies the case to which the request pertains. A drop-list of cases the user owns is preferably used to select the associated case.

A user may also choose to perform a search on a lead or tip prior to creating a case in the system to see if other entities are investigating the subject. If results exist, he/she may choose to generate a case. Since no case exists, the user has the ability to create a “placeholder case” which will be automatically created and any requests will be associated to the new placeholder case. This makes it possible for the user to continue a linear workflow without having to first create cases prior to performing searches.

### 7. Data Integrity and Security within the System

### 7.1. Data Segregation

Recent high-profile database break-ins have highlighted the problem with having one omniscient database of knowledge—especially as it crosses individual lines. Therefore, an important part of the system design is to allow collaboration and searches while maintaining as large a barrier as possible between different entities' information—such that even someone with full administrative rights to the system will not have complete access to everyone's data.

One simple example of this comes in the sharing of unstructured (e.g., unsearchable) data. By storing on the server data encrypted with a private key belonging to a specific customer, one can have the customer share the data by re-encoding the header in such a way as to be decipherable by the intended recipient and themselves without making it generally available. There are numerous “key exchange” and “public key cryptography” systems well suited to this form of task (e.g., PGP), as will be appreciated by those skilled in the art.

This sort of internal firewall to information exchange is complemented by the usual methods of transmission security such as SSL.

### 7.2. Securing Data for Search

Some of the data is by necessity shared to allow for the detection of coincidences. There are two types of security possible for this data both corresponding to well known cryptographic techniques.

First, the individual fields (name, address, id, etc.) can be replaced by a cryptographic hash or one-way function. The hash has the property that given the hashed value it is impossible to reconstruct the original data, however two identical strings will always yield the same hash allowing for match detection.

For fields in which the possibility of partial matches, such as name and address, is desired, such situations can be addressed by decomposing a single field into multiple smaller fields (such as name breaks into first name, last name, and address into street, city, state, etc.).

The second aspect of the shared data is the links that point from an individual record to the investigator who posted it. In this case, the goal is to allow the user to detect coincidences but obscure with whom they have a coincidence. There are multiple approaches including having every entry keyed with a random key for which everyone knows what keys they contributed but not what keys correspond to other people. Then, when one posts a request for information it can enter a queue and everyone will be able to pick out the notes in the queue corresponding to them. If the key is made to correspond to a secret key, the RFI can be encrypted and the intended recipient is guaranteed to be the only one who can read and respond to the request.

### 7.3. Securing Data for Collaboration

As part of document creation, there are an increasing number of tools available via PDF or in the new Office 12 software from Microsoft that enable Digital Rights Management. This is basically a means for ensuring that an email containing a document to be shared can, for example, be read but not printed, read but not saved, or saved but not forwarded outside the organization. As the new Office tools gain wider acceptance, this will be an increasingly important aspect of the system that can be leveraged.

### 7.4. Tracking All Actions via Secure Audit Logging

Every action taken generates an audit trail and this trail is stored redundantly in multiple independent sites. In some cases a cryptographic hash of the audit record is recorded as a check against tampering.

### 7.5. Automated Detection of System Misuse

Another aspect of the system is an activity monitor looking for unusual patterns. If, for example, someone in the Eastern Time zone who has previously only submitted queries from 9 am to 5 pm and always from the same IP address starts making queries at 2 am from an unknown address, an exception will be logged and in extreme cases the account will be locked out pending investigation. It is also possible for an investigator to become compromised where they may be using the system to notify perpetrators if an investigation has been opened. If, for example, a user always searches for Pat Smith, but never acts upon any results, this activity will be logged and administrators notified of the suspicious activity.

The present invention, among other things, discloses an online system and method for exchanging fraud investigation information, which can find many applications in a wide spectrum of fields. The healthcare and insurance industries will be the first area of focused attention. The present invention is also applicable to any industry that conducts routine audits that can cross state borders/jurisdictions (e.g. Banking, Welfare, Workman's Compensation, etc.).

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A system for selectively sharing information regarding a plurality of fraud investigation cases, each of the plurality of fraud investigation cases being associated with an entity, comprising:
a. a database for storing the information;
b. a web server in communication with the database for managing the information stored therein; and
c. a policy control module in communication with the database and the web server for creating and implementing rules to allow the entity to limit to whom one of its selected cases is exposed, such that when entity A is assigned to share with entity B, the case associated with entity A is exposable/searchable to entity B, and vice versa.

2. The system of claim 1, further comprising a data ingest module adapted for
a. receiving cases from existing case tracking systems;
b. receiving search indices from a remotely deployed system application;
c. applying a secured file transfer protocol (SFTP) for automated upload of cases into a designated folder of the entity;
d. performing data normalization for batch upload;
e. creating or entering an individual case; and
f. ingesting past action data file.

3. The system of claim 2, further comprising a case management module adapted for entering, editing, reviewing, and disposing of cases.

4. The system of claim 3, further comprising a case collaboration module adapted for generating a request for information (RFI) on behalf of a second entity and for facilitating the sharing of agreed upon information for selected cases between the entity and the second entity.

5. The system of claim 4, further comprising a search module adapted for searching cases for various attribute data in accordance with search criteria of a requesting entity.

6. The system of claim 5, further comprising a reporting module adapted for generating reports in accordance with the needs and requirements of the requesting entity.

7. A method for selectively sharing information including a plurality of fraud investigatory cases, each of the plurality of cases being associated with a respective entity, comprising the steps of:
a. storing the information associated with each case in a database;
b. using a web server, managing and controlling access to the information associated with each case based on rules created and agreed to by the entities; and
c. providing one entity with access to a respective case of a second entity based on the rules whereby the respective case is viewable and searchable by the second entity by means of the web server.

8. The method of claim 7, further comprising the steps of:
a. receiving cases into the database from existing case tracking systems;
b. receiving search indices from a remotely deployed system application;
c. applying a secured file transfer protocol (SFTP) for automated upload cases into a hot folder assigned to each respective entity;
d. performing data normalization for batch upload;
e. creating or entering an individual case into the database; and
f. ingesting past action data file into the individual case.

9. The method of claim 8, further comprising the steps of entering, editing, reviewing, and/or disposing of cases.

10. The method of claim 9, further comprising the steps of generating a request for information (RFI) on behalf of the second entity, and, based on the rules, identifying what information can be shared.

11. The method of claim 10, further comprising the step of searching cases for various attribute data in accordance with search criteria of the second entity.

12. The method of claim 11, further comprising the step of generating reports in accordance with the needs and requirements of the second entity.

13. Software stored on a computer readable medium for causing a computing system to perform functions comprising:
a. storing a plurality of cases, each of the plurality of cases being associated with an entity; and
b. creating rules to allow an entity to limit to whom his/her case is exposed, such that when entity A is assigned to share with entity B, the case associated with entity A is exposable/searchable to entity B, and vice versus.

14. The software of claim 13, wherein the functions further comprise:
a. receiving cases from existing case tracking systems;
b. receiving search indices from a remotely deployed system application;
c. applying a secured file transfer protocol (SFTP) for automated upload cases into a hot folder per entity;
d. performing data normalization for batch upload;
e. creating and/or entering a individual case; and
f. ingesting past action data file.

15. The software of claim 14, wherein the functions further comprise entering, editing, reviewing, and/or disposing of cases.

16. The software of claim 15, wherein the functions further comprise generating a request for information (RFI) on behalf of another entity, and deciding what information can be shared.

17. The software of claim 16, wherein the functions further comprise searching cases for various attribute data in accordance with search criteria of an entity.

18. The software of claim 17, wherein the functions further comprise generating reports in accordance with the needs and requirements of the entity.
